(19) United States
(12) Patent Application Publication
(10) Pub. No.: US 2025/0307715 A1
(43) Pub. Date: Oct. 2, 2025

(54) BURIAL ENVIRONMENT CLASSIFICATION MAP CREATION APPARATUS, BURIED PIPE DETERIORATION DEGREE PREDICTION APPARATUS, BURIAL ENVIRONMENT CLASSIFICATION MAP CREATION METHOD, AND NON-TRANSITORY COMPUTER-READABLE RECORDING MEDIUM

(71) Applicant: Kubota Corporation, Osaka (JP)

(72) Inventors: Yuichi KOBAYASHI, Amagasaki-shi (JP); Yuta OKUMURA, Amagasaki-shi (JP); Shimpei TAKAHASHI, Sakai-shi (JP)

(21) Appl. No.: 19/240,247

(22) Filed: Jun. 17, 2025

Related U.S. Application Data
(63) Continuation of application No. PCT/JP2023/043624, filed on Dec. 6, 2023.

(30) Foreign Application Priority Data
Dec. 19, 2022 (JP) 2022-201995

(51) Int. Cl. G06N 20/00; F17D 5/02

(52) U.S. Cl. CPC G06N 20/00; F17D 5/02

(57) ABSTRACT

A buried pipe deterioration degree prediction apparatus includes a buried pipe deterioration degree calculator configured or programmed to calculate a deterioration degree for each of buried pipes based on a buried pipe deterioration degree prediction model and a burial environment of each of the buried pipes identified by an optimized burial environment classification map created by optimizing the burial environment classification of a portion of grounds in a general burial environment classification map by machine learning. The portion of grounds is selected based on water leakage accident data that provides a past record of water leakage accidents for each of the buried pipes.

### CROSS REFERENCE TO RELATED APPLICATIONS

This application claims the benefit of priority to Japanese Patent Application No. 2022-201995 filed on Dec. 19, 2022 and is a Continuation application of PCT Application No. PCT/JP2023/043624 filed on Dec. 6, 2023. The entire contents of each application are hereby incorporated herein by reference.

### BACKGROUND OF THE INVENTION

### 1. Field of the Invention

The present disclosure relates to burial environment classification map creation apparatuses, buried pipe deterioration degree prediction apparatuses, burial environment classification map creation methods, buried pipe deterioration degree prediction methods, and non-transitory computer-readable media including programs.

### 2. Description of the Related Art

A pipe, such as a water pipe, is buried in the soil. During long-term use of the pipe, the pipe may be subject to corrosion. Japanese Patent Laid-Open No. 2007-107882 discloses a method of predicting a degree of corrosion of a buried pipe.

### SUMMARY OF THE INVENTION

Example embodiments of the present invention provide burial environment classification map creation apparatuses, buried pipe deterioration degree prediction apparatuses, burial environment classification map creation methods, buried pipe deterioration degree prediction methods, and non-transitory computer-readable media including programs, each of which makes it possible to predict a deterioration degree for a buried pipe more accurately.

A burial environment classification map creation apparatus according to an example embodiment of the present disclosure includes at least one of a processor or an integrated circuit configured or programmed to include a first map creator and a second map creator. The first map creator is configured or programmed to create, based on a pipeline map which is a map of buried pipes and a generally available geological map, a general burial environment classification map for a region corresponding to the pipeline map. The second map creator is configured or programmed to include a ground selector and an optimized burial environment classification map creator. The ground selector is configured or programmed to select a portion of grounds from the general burial environment classification map based on leakage accident data which is a past record of water leakage accidents for each of the buried pipes. The optimized burial environment classification map creator is configured or programmed to create an optimized burial environment classification map for the region by optimizing a burial environment classification of the portion of grounds by machine learning.

A buried pipe deterioration degree prediction apparatus according to an example embodiment of the present disclosure includes at least one of a processor or an integrated circuit configured or programmed to include a buried pipe deterioration degree calculator configured or programmed to calculate a deterioration degree for each of the buried pipes based on a burial environment of each of the buried pipes identified by an optimized burial environment classification map optimized for a region corresponding to a pipeline map which is a map of buried pipes, first information related to a burial period of each of the buried pipes, second information related to a pipe wall thickness of each of the buried pipes, and a buried pipe deterioration degree prediction model. The optimized burial environment classification map is created by optimizing a burial environment classification of a portion of grounds in a general burial environment classification map for the region by machine learning. The general burial environment classification map is created based on the pipeline map and a generally available geological map. The portion of grounds is selected from the general burial environment classification map based on water leakage accident data which is a past record of water leakage accidents for each of the buried pipes.

A burial environment classification map creation method according to an example embodiment of the present disclosure includes a step of creating, based on a pipeline map which is a map of buried pipes and a generally available geological map, a general burial environment classification map for a region corresponding to the pipeline map, a step of selecting a portion of grounds from the general burial environment classification map based on water leakage accident data which is a past record of water leakage accidents for each of the buried pipes, and a step of creating an optimized burial environment classification map for the region by optimizing a burial environment classification of the portion of grounds by machine learning.

A buried pipe deterioration degree prediction method according to an example embodiment of the present disclosure includes a step of calculating a deterioration degree for each of the buried pipes based on a burial environment of each of the buried pipes identified by an optimized burial environment classification map optimized for a region corresponding to a pipeline map which is a map of buried pipes, first information related to a burial period of each of the buried pipes, second information related to a pipe wall thickness of each of the buried pipes, and a buried pipe deterioration degree prediction model. The optimized burial environment classification map is created by optimizing a burial environment classification of a portion of grounds in a general burial environment classification map for the region by machine learning. The general burial environment classification map is created based on the pipeline map and a generally available geological map. The portion of grounds is selected from the general burial environment classification map based on water leakage accident data which is a past record of water leakage accidents for each of the buried pipes.

A non-transitory computer-readable medium including a program according to an example embodiment of the present disclosure causes a processor to execute each step of a burial environment classification map creation method according to an example embodiment of the present disclosure.

A non-transitory computer-readable medium including a program according to an example embodiment of the present disclosure causes a processor to execute each step of a buried pipe deterioration degree prediction method according to an example embodiment of the present disclosure.

The burial environment classification map creation apparatuses, the buried pipe deterioration degree prediction apparatuses, the burial environment classification map creation methods, the buried pipe deterioration degree prediction methods, and non-transitory computer-readable media including programs according to example embodiments of the present disclosure, more accurately predict a deterioration degree for a buried pipe.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram illustrating a hardware configuration of a buried pipe deterioration degree prediction apparatus according to an example embodiment of the present invention.

FIG. 2 is a block diagram illustrating a functional configuration of a buried pipe deterioration degree prediction apparatus according to an example embodiment of the present invention.

FIG. 3 is a block diagram illustrating a functional configuration of a correspondence table creator of a buried pipe deterioration degree prediction apparatus according to an example embodiment of the present invention.

FIG. 4 is a block diagram illustrating a functional configuration of a second map creator of a buried pipe deterioration degree prediction apparatus according to an example embodiment of the present invention.

FIG. 5 is a block diagram illustrating a functional configuration of a fitness calculator of a buried pipe deterioration degree prediction apparatus according to an example embodiment of the present invention.

FIG. 6 is a block diagram illustrating a functional configuration of a storage of a buried pipe deterioration degree prediction apparatus according to an example embodiment of the present invention.

FIG. 7 is a diagram illustrating an example data structure of survey pipe data.

FIG. 8 is a schematic diagram illustrating a geological map.

FIG. 9 is a diagram illustrating an example data structure of a correspondence table between geological information, ground IDs, corrosion rates and burial environments.

FIG. 10 is a box plot illustrating a relationship between a burial environment and a corrosion rate.

FIG. 11 is a diagram illustrating a pipeline map.

FIG. 12 is a diagram illustrating an example data structure of buried pipe attribute data.

FIG. 13 is a diagram illustrating an example data structure of water leakage accident data.

FIG. 14 is a diagram illustrating a general integrated map.

FIG. 15 is a diagram illustrating an optimized integrated map.

FIG. 16 is a diagram illustrating an example data structure of nominal pipe wall thickness data.

FIG. 17 is a diagram illustrating an example of calculating an estimated probability of water leakage accidents by using a probability-of-water-leakage-accidents prediction model.

FIG. 18 is a diagram illustrating an example of a buried pipe deterioration degree prediction result (a buried pipe deterioration degree prediction table).

FIG. 19 is a diagram illustrating an example of a buried pipe deterioration degree prediction result (a buried pipe deterioration degree prediction map).

FIG. 20 is a flowchart illustrating a correspondence table creation method according to an example embodiment of the present invention.

FIG. 21 is a flowchart illustrating a method of creating an optimized integrated map according to an example embodiment of the present invention.

FIG. 22 is a flowchart illustrating a step of creating an optimized integrated map according to an example embodiment of the present invention.

FIG. 23 is a flowchart illustrating a step of selecting a ground ID as a candidate for optimizing the burial environment classification.

FIG. 24 is a flowchart illustrating a step of excluding a ground ID with a burial environment classification that does not need to change.

FIG. 25 is a flowchart illustrating a step of calculating an estimated number of water leakage accidents.

FIG. 26 is a diagram illustrating an example data structure of first preprocessed buried pipe data.

FIG. 27 is a flowchart illustrating a step of creating first preprocessed buried pipe data.

FIG. 28 is a flowchart illustrating a step of optimizing a burial environment classification of a ground ID selected as a candidate for optimizing a burial environment classification by machine learning.

FIG. 29 is a diagram illustrating example genes of each of a plurality of burial environment map candidates.

FIG. 30 is a flowchart illustrating a step of generating a population of new generations.

FIG. 31 is a flowchart illustrating a step of calculating fitness of each individual in a population of current generations.

FIG. 32 is a diagram illustrating an example data structure of second preprocessed buried pipe data.

FIG. 33 is a flowchart illustrating a step of creating second preprocessed buried pipe data.

FIG. 34 is a diagram illustrating an example data structure of an estimated probability-of-water-leakage-accidents result of an individual.

FIG. 35 is a diagram illustrating an example fitness of an individual.

FIG. 36 is a flowchart illustrating a method of predicting a deterioration degree for a buried pipe according to an example embodiment of the present invention.

FIG. 37 is a flowchart illustrating a step of calculating an estimated probability of water leakage accidents.

FIG. 38 is a diagram illustrating an example data structure of third preprocessed buried pipe data.

FIG. 39 is a flowchart illustrating a step of creating third preprocessed buried pipe data.

FIG. 40 is a diagram illustrating an example of calculating a deterioration degree for a buried pipe based on a buried pipe deterioration degree prediction model.

FIG. 41 is a diagram illustrating a schematic configuration of a buried pipe deterioration degree prediction system according to a modification of an example embodiment of the present invention.

### DETAILED DESCRIPTION OF THE EXAMPLE EMBODIMENTS

Hereinafter, example embodiments of the present disclosure will be described. The same components will be denoted by the same reference numerals, and the description thereof will not be repeated.

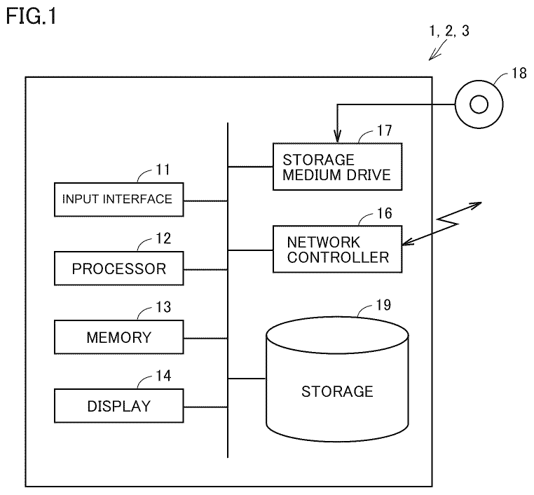

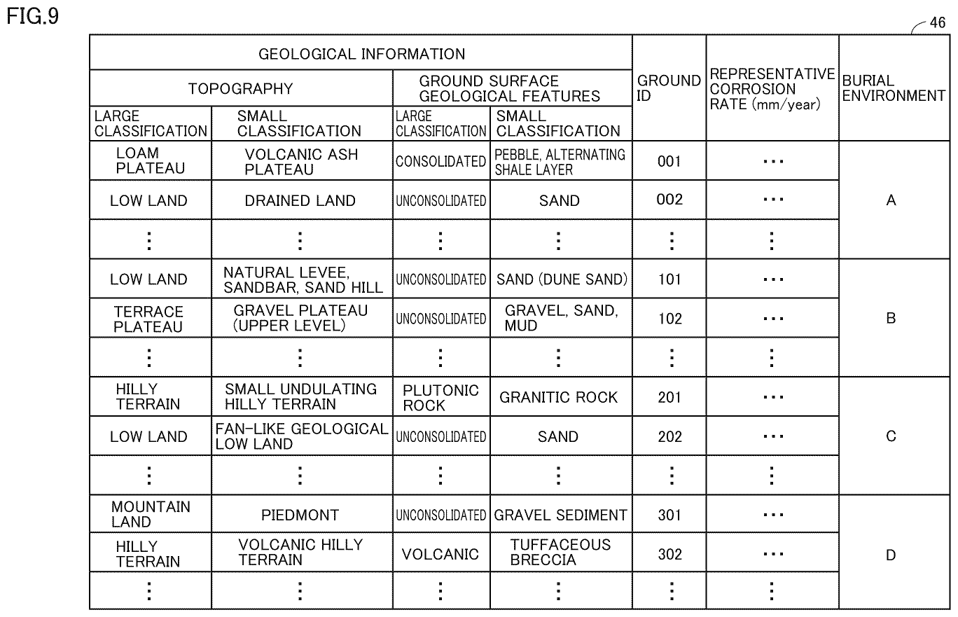

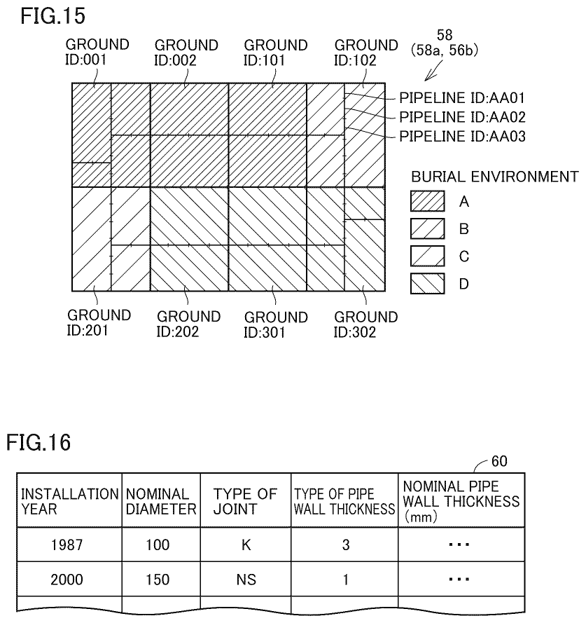

A buried pipe deterioration degree prediction apparatus 1 will be described with reference to FIGS. 1 to 6. The buried pipe deterioration degree prediction apparatus 1 is an apparatus that predicts a deterioration degree for a buried pipe. In the present example embodiment, the buried pipe deterioration degree prediction apparatus 1 also functions as a burial environment classification map creation apparatus 2 and a correspondence table creation apparatus 3. The burial environment classification map creation apparatus 2 is an apparatus that creates an optimized burial environment classification map 58a (see FIG. 15). The correspondence table creation apparatus 3 is an apparatus that creates a correspondence table 46 between geological information, ground IDs, corrosion rates and burial environments (hereinafter simply referred to as “correspondence table 46” (see FIG. 9)).

With reference to FIG. 1, a hardware configuration of the buried pipe deterioration degree prediction apparatus 1 will be described. The buried pipe deterioration degree prediction apparatus 1 includes an input interface 11, a processor 12, a memory 13, a display 14, a network controller 16, a storage medium drive 17, and a storage 19.

The input interface 11 receives various types of input operations. The input interface 11 is, for example, a keyboard, a mouse, or a touch panel.

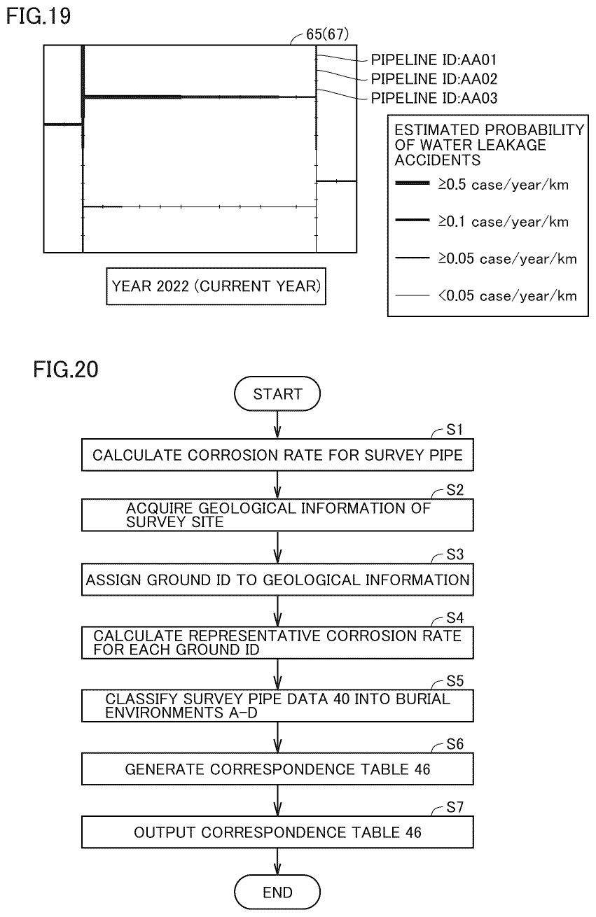

The display 14 displays information or the like required to be processed by the buried pipe deterioration degree prediction apparatus 1. The display 14 displays, for example, an optimized integrated map 58 (see FIG. 15) and a buried pipe deterioration degree prediction result 65 (see FIGS. 18 and 19). The display 14 is, for example, an LCD (Liquid Crystal Display) or an organic EL (Electroluminescence) display.

The processor 12 is configured or programmed to execute a process required to implement the functions of the buried pipe deterioration degree prediction apparatus 1 by executing a program (which will be described later). The processor 12 includes, for example, a CPU, a GPU, or the like.

The memory 13 provides a storage area to temporarily store program codes or a work memory when the processor 12 executes a program. The memory 13 is, for example, a volatile memory device such as DRAM (Dynamic Random Access Memory) or SRAM (Static Random Access Memory).

The network controller 16 is configured or programmed to transmit and receive a program or data to and from an external device (not shown) via a communication network (not shown) such as the Internet or an intranet. For example, the network controller 16 is configured or programmed to transmit the optimized integrated map 58 (see FIG. 15) and the buried pipe deterioration degree prediction result 65 (see FIGS. 18 and 19) to an external device via a communication network. The network controller 16 may receive buried pipe data 50 (see FIGS. 11 and 12) from a client (for example, a water supply corporation) via a communication network. The network controller 16 supports any communication system such as Ethernet (registered trademark), wireless LAN, or Bluetooth (registered trademark).

The storage medium drive 17 is a device that reads out a program or data stored in a storage medium 18. The storage medium drive 17 may also be a device that writes a program or data to the storage medium 18. The storage medium 18 is a non-transitory storage medium, and stores a program or data in a non-volatile manner. The storage medium 18 is, for example, an optical storage medium such as an optical disk (for example, a CD-ROM or a DVD-ROM), a semiconductor storage medium such as a flash memory or a USB memory, a magnetic storage medium such as a floppy disk (FD) or a storage tape, or a magneto-optical storage medium such as a magneto-optical (MO) disk.

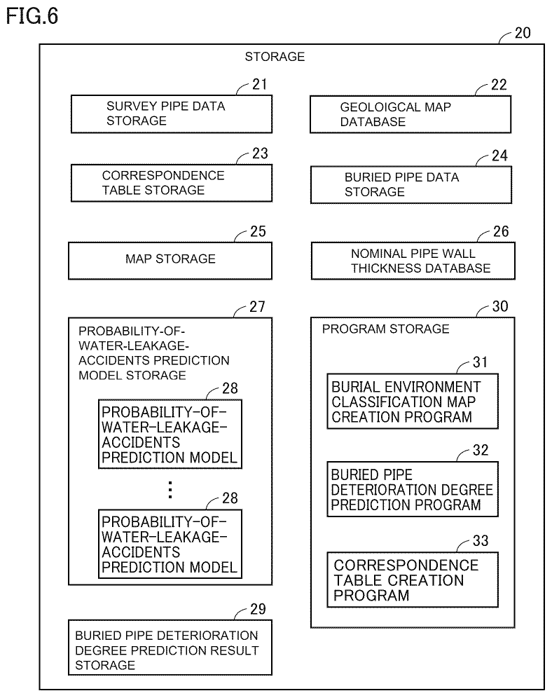

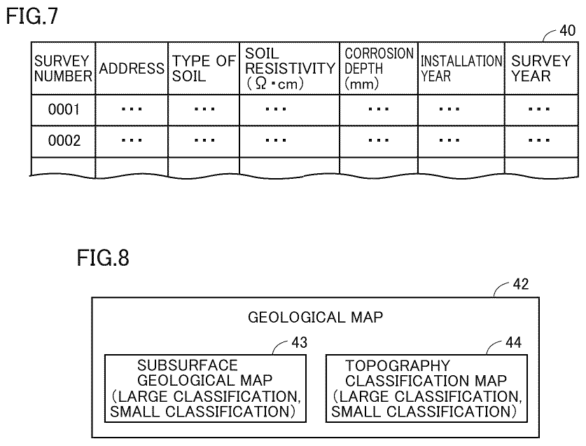

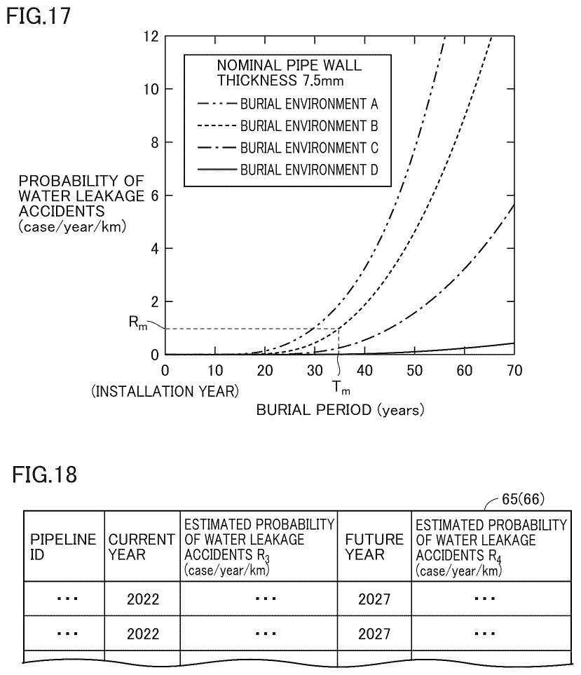

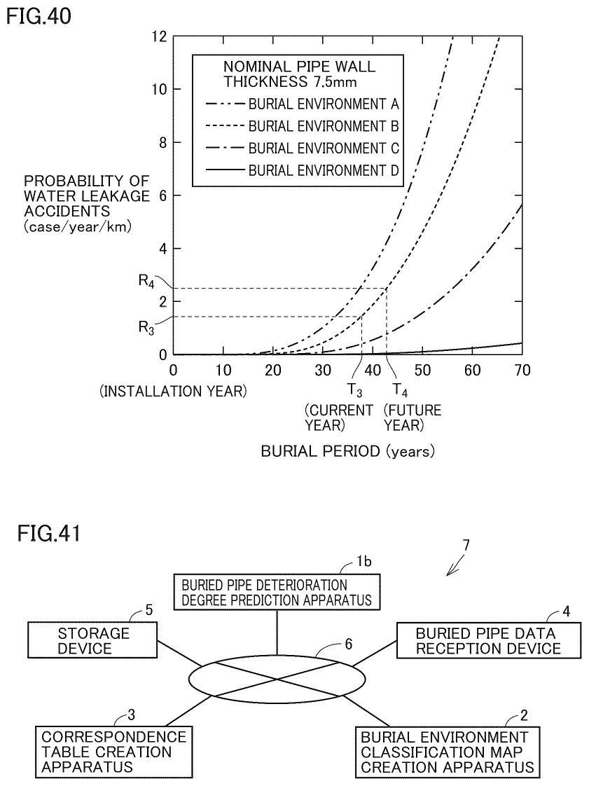

The storage 19 is, for example, a nonvolatile memory device such as a hard disk or a solid state drive (SSD). The storage 19 stores survey pipe data 40 (see FIG. 7), a geological map 42 (see FIG. 8), a correspondence table 46 (see FIG. 9), buried pipe data 50 (see FIG. 11 and FIG. 12), a general integrated map 56 (see FIG. 14), an optimized integrated map 58 (see FIG. 15), nominal pipe wall thickness data 60 (see FIG. 16), a probability-of-water-leakage-accidents prediction model 28 (see FIG. 6, FIG. 17 and FIG. 40), a buried pipe deterioration degree prediction result 65, programs to be executed in the processor 12, and the like. The programs include a burial environment classification map creation program 31 (see FIG. 6), a buried pipe deterioration degree prediction program 32 (see FIG. 6), and a correspondence table creation program 33 (see FIG. 6).

The programs that are executable to perform the functions of the buried pipe deterioration degree prediction apparatus 1, such as the burial environment classification map creation program 31 (see FIG. 6), the buried pipe deterioration degree prediction program 32 (see FIG. 6), and the correspondence table creation program 33 (see FIG. 6), may be stored in the non-transitory storage medium 18 for distribution, and may be installed in the storage 19. The programs that are executable to perform the functions of the buried pipe deterioration degree prediction apparatus 1, such as the burial environment classification map creation program 31, the buried pipe deterioration degree prediction program 32, and the correspondence table creation program 33, may be downloaded to the buried pipe deterioration degree prediction apparatus 1 via the Internet or an intranet.

In the present example embodiment, it is described that a general-purpose computer (e.g., processor 12) is configured or programmed to implement the functions of the buried pipe deterioration degree prediction apparatus 1 by executing a program. All or a portion of the functions of the buried pipe deterioration degree prediction apparatus 1 may be implemented by using an integrated circuit such as an application specific integrated circuit (ASIC) or a field programmable gate array (FPGA).

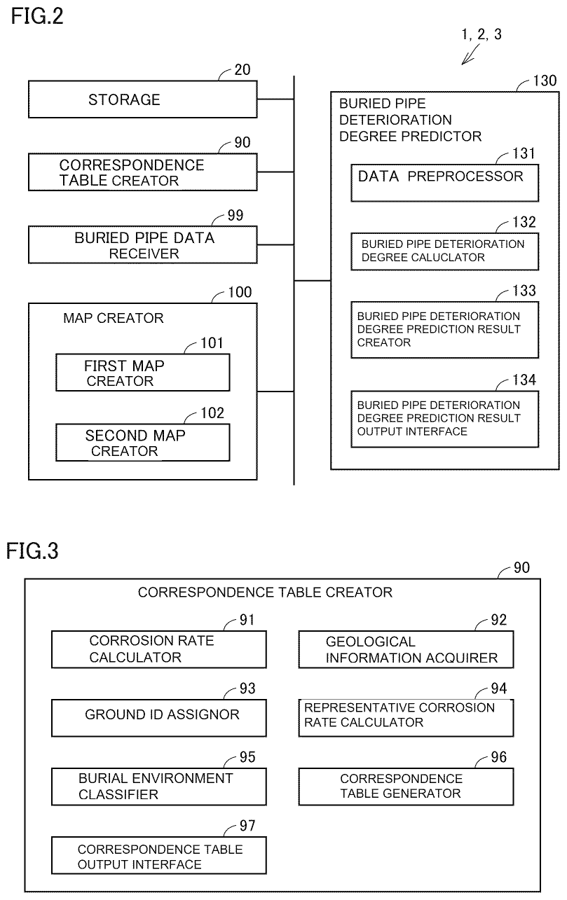

An example functional configuration of the buried pipe deterioration degree prediction apparatus 1 will be described with reference to FIGS. 2 to 19. With reference to FIG. 2, the buried pipe deterioration degree prediction apparatus 1 includes at least one of the processor 12 or the integrated circuit described above, configured or programmed to provide or include a storage 20, a correspondence table creator 90, a buried pipe data receiver 99, a map creator 100, and a buried pipe deterioration degree predictor 130.

The storage 20 is implemented by the storage 19 (see FIG. 1) or the storage medium 18 (see FIG. 1). With reference to FIG. 6, the storage 20 includes a survey pipe data storage 21, a geological map database 22, a correspondence table storage 23, a buried pipe data storage 24, a map storage 25, a nominal pipe wall thickness database 26, a probability-of-water-leakage-accidents prediction model storage 27, a buried pipe deterioration degree prediction result storage 29, and a program storage 30.

With reference to FIGS. 6 and 7, the survey pipe data 40 is stored in the survey pipe data storage 21. A survey pipe is, for example, a water pipe. The survey pipe is buried in soil. The survey pipe data 40 is, for example, survey data of pipes obtained by digging and surveying pipes at a large number of survey sites (for example, about 6000 survey sites) throughout Japan. The survey pipe data 40 includes a survey number, a survey site's address, a type of soil, a soil resistivity, a corrosion depth of a survey pipe, an installation year, and a survey year. The survey site's address refers to the address of a survey site where the survey pipe is buried. The type of soil is the type of soil where the survey pipe is buried. The soil resistivity refers to the resistivity of the soil where the survey pipe is buried. The survey year is the year when the corrosion depth of the survey pipe was surveyed. The survey pipe data 40 is provided, for example, through the storage medium 18 (see FIG. 1) or a communication network such as the Internet or an intranet.

With reference to FIGS. 6 and 8, the geological map 42 is stored in the geological map database 22. The geological map 42 includes, for example, a subsurface geological map 43 and a topography classification map 44. The subsurface geological map 43 is a map illustrating the geography of the ground surface. The subsurface geological map 43 includes, for example, a large classification and a small classification. The topography classification map 44 is a map illustrating the topography. The topography classification map 44 includes, for example, a large classification and a small classification. The surface geographic map 43 and the topography classification map 44 are provided by a public organization such as the Ministry of Land, Infrastructure, Transport and Tourism of Japan, and are generally available.

With reference to FIGS. 6 and 9, the correspondence table 46 is stored in the correspondence table storage 23. The correspondence table 46 is created based on the survey pipe data 40 and the geological map 42. In the correspondence table 46, the geological information, the ground ID, the representative corrosion rate, and the burial environment are associated with each other.

The geological information is, for example, a combination of the ground surface geological features and the topography of the survey site (see FIG. 7). The ground ID is assigned according to the geological information. The representative corrosion rate for each ground ID is, for example, an average corrosion rate for each ground ID or a median corrosion rate for each ground ID. The average corrosion rate for each ground ID is an average value of the corrosion rates of the survey pipes to which the same ground ID is assigned. The median corrosion rate for each ground ID is a 50th percentile value of the corrosion rates of the survey pipes to which the same ground ID is assigned.

In the correspondence table 46, the survey pipe data 40 is classified into four burial environments A to D based on the type of soil (see FIG. 7) and the soil resistivity (see FIG. 7). The burial environment A represents a soil having a soil resistivity of less than about 1500 Ω·cm or a soil having a corrosivity to a buried pipe which is equivalent to that of the aforementioned soil, for example. The burial environment B represents a clay soil having a soil resistivity of about 1500 Ω·cm or more or a soil having a corrosivity to a buried pipe which is equivalent to that of the clay soil, for example. The burial environment C represents a silty soil having a soil resistivity of about 1500 Ω·cm or more or a soil having a corrosivity to a buried pipe which is equivalent to that of the silty soil, for example. The burial environment D represents a sandy soil having a soil resistivity of about 1500 Ω·cm or more or a soil having a corrosivity to a buried pipe which is equivalent to that of the sandy soil, for example. Among the burial environments A to D, the burial environment A has the highest corrosivity to the buried pipe.

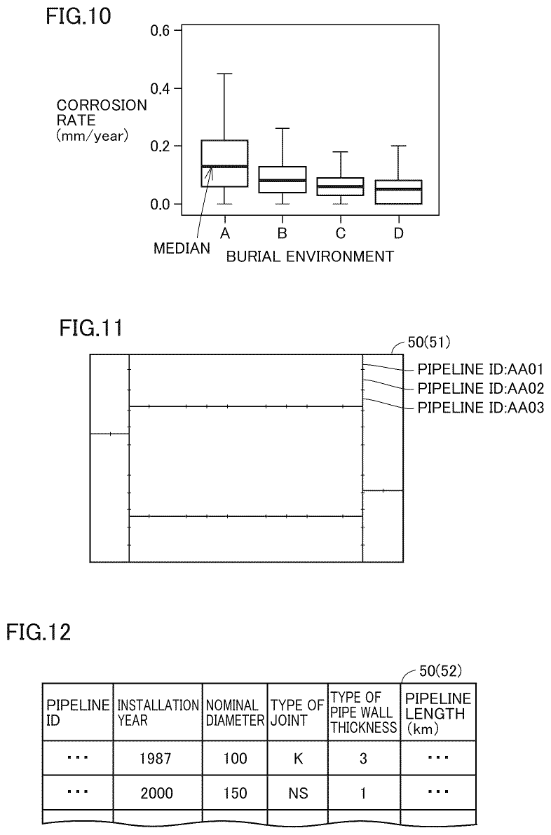

The soil in which a buried pipe is buried is classified into four burial environments A to D due to the following two reasons. The first reason is that the inventors of example embodiments of the present disclosure have discovered that there is a statistically significant correlation between the burial environments A to D and the corrosion rate of a buried pipe as illustrated in FIG. 10 based on an analysis on the survey pipe data 40. The second reason is that the number of survey data concerning the four burial environments A to D accounts for the majority (e.g., about 80% or more) of the total number of the survey data.

As illustrated in FIG. 10, the median corrosion rate of the soil classified into the burial environment A is the largest among the median corrosion rates of all the burial environments A to D. The burial environment A has the highest corrosivity to a buried pipe among all the burial environments A to D. The median corrosion rate of the soil classified into the burial environment B is the second largest among the median corrosion rates of all the burial environments A to D. The median corrosion rate of the soil classified into the burial environment B is the third smallest among the median values of all the burial environments A to D. The burial environment B has a lower corrosivity to the buried pipe than the burial environment A, and has a higher corrosivity to the buried pipe than the burial environment C and the burial environment D. The median corrosion rate of the soil classified into the burial environment C is the second smallest among the median corrosion rates of all the burial environments A to D. The burial environment C has a lower corrosivity to the buried pipe than the burial environment A and the burial environment B, but has higher corrosivity to the buried pipe than the burial environment D. The median corrosion rate of the soil classified into the burial environment D is the smallest among the median corrosion rates of all the burial environments A to D. The burial environment D has the lowest corrosivity to the buried pipe among all the burial environments A to D.

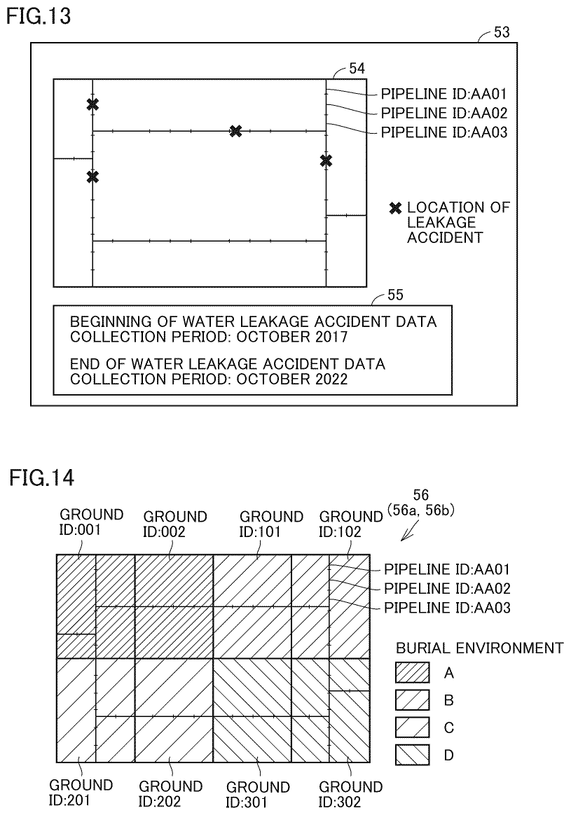

With reference to FIGS. 6 and 11 to 13, buried pipe data 50 (see FIGS. 11 and 12) and water leakage accident data 53 (see FIG. 13) are stored in the buried pipe data storage 24. The use of the buried pipe is the same as the use of the survey pipe, and the buried pipe is, for example, a water pipe. The buried pipe is buried in soil.

The buried pipe data 50 includes, for example, a pipeline map 51 (see FIG. 11) and buried pipe attribute data 52 (see FIG. 12).

With reference to FIG. 11, the pipeline map 51 is a map of buried pipes managed by a client, and includes a pipeline ID of each buried pipe and an address (burial site) of each buried pipe. In the pipeline map 51, the pipeline ID of each buried pipe and the address of each buried pipe are associated with each other, and the address of each buried pipe is displayed on the map for the pipeline ID of each buried pipe.

With reference to FIG. 12, the buried pipe attribute data 52 includes first information related to a burial period of each buried pipe and second information related to a pipe wall thickness of each buried pipe. The buried pipe attribute data 52 includes, for example, a pipeline ID and a pipeline length of each buried pipe, an installation year of each buried pipe as the first information, and a nominal diameter, a type of joint and a type of pipe wall thickness of each buried pipe as the second information. In the buried pipe attribute data 52, the pipeline ID, the installation year, the nominal diameter, the type of joint, the type of pipe wall thickness, and the pipeline length are associated with each other. The installation year of each buried pipe is the year in which each buried pipe is installed (buried). The type of joint includes type A, type K, type T, and type NS. The type of pipe wall thickness includes type 1, type 2, type 3, or the like. The pipeline length is the length of buried pipes.

With reference to FIG. 13, the water leakage accident data 53 is a past record of water leakage accidents for each of the buried pipes. The water leakage accident data 53 includes, for example, a water leakage accident map 54 and a beginning and an end of a water leakage accident data collection period 55. The water leakage accident map 54 is a map illustrating locations recorded with water leakage accidents in the pipeline map 51 during the water leakage accident data collection period 55.

The map storage 25 stores a general integrated map 56 (see FIG. 14) for the region corresponding to the pipeline map 51 and an optimized integrated map 58 (see FIG. 15) for the region corresponding to the pipeline map 51.

With reference to FIG. 14, the general integrated map 56 is an integrated map of the pipeline map 51, a general burial environment classification map 56a for a region corresponding to the pipeline map 51, and a ground ID map 56b for the region corresponding to the pipeline map 51. The general burial environment classification map 56a is a map indicating a burial environment for the region corresponding to the pipeline map 51. The ground ID map 56b is a map indicating a ground ID for the region corresponding to the pipeline map 51.

With reference to FIG. 15, the optimized integrated map 58 is an integrated map of the pipeline map 51, an optimized burial environment classification map 58a for a region corresponding to the pipeline map 51, and a ground ID map 56b for a region corresponding to the pipeline map 51. The optimized burial environment classification map 58a is created by optimizing a burial environment classification of the general burial environment classification map 56a based on the water leakage accident data 53.

With reference to FIGS. 6 and 16, the nominal pipe wall thickness data 60 is stored in the nominal pipe wall thickness database 26. The nominal pipe wall thickness data 60 includes, for example, an installation year, a nominal diameter, a type of joint, a type of pipe wall thickness, and a nominal pipe wall thickness of each buried pipe. In the nominal pipe wall thickness data 60, the installation year, the nominal diameter, the type of joint, the type of pipe wall thickness, and the nominal pipe wall thickness of each buried pipe are associated with each other. The nominal pipe wall thickness refers to the standard pipe wall thickness.

With reference to FIG. 6, the probability-of-water-leakage-accidents prediction model storage 27 stores a plurality of probability-of-water-leakage-accidents prediction models 28 which are different from each other according to the burial environment and the nominal pipe wall thickness. The plurality of probability-of-water-leakage-accidents prediction models 28 includes, for example, a probability-of-water-leakage-accidents prediction model for the burial environment A, a probability-of-water-leakage-accidents prediction model for the burial environment B, a probability-of-water-leakage-accidents prediction model for the burial environment C, and a probability-of-water-leakage-accidents prediction model for the burial environment D. Each of the probability-of-water-leakage-accidents prediction model for the burial environment A, the probability-of-water-leakage-accidents prediction model for the burial environment B, the probability-of-water-leakage-accidents prediction model for the burial environment C, and the probability-of-water-leakage-accidents prediction model for the burial environment D includes a plurality of probability-of-water-leakage-accidents prediction models, each for a nominal pipe wall thickness. FIG. 17 illustrates a plurality of probability-of-water-leakage-accidents prediction models 28 as an example. The plurality of probability-of-water-leakage-accidents prediction models 28 are not particularly limited, and may be, for example, a probability-of-water-leakage-accidents prediction model disclosed in Japanese Patent Laid-Open No. 2021-56224, or may be a probability-of-water-leakage-accidents estimation formula for a buried pipe provided by the Water Research Center of Japan.

The probability-of-water-leakage-accidents estimation formula for a buried pipe provided by the Water Research Center of Japan is given by the following equation (1). Where y represents a probability of water leakage accidents (case/km/year) of a buried pipe, C₁ represents a correction coefficient for the pipe specification, C₂ represents a correction coefficient for the pipe diameter, C₃ represents a correction coefficient for the conditions of ground where the buried pipe is buried, and f(T) represents the standard accident rate curve for each pipe type. Here, f(T) is given by the following equation (2). Where T represents a buried period of a buried pipe, and coefficients a and b represent the degree of increase in the probability of water leakage accidents for each pipe type over time.

Y=C₁·C₂·C₃·f(T) (1)

f(T)=a·T^{b} (2)

With reference to FIG. 6, the buried pipe deterioration degree prediction result 65 is stored in buried pipe deterioration degree prediction result storage 29. The buried pipe deterioration degree prediction result 65 may be the buried pipe deterioration degree prediction table 66 (see FIG. 18), the buried pipe deterioration degree prediction map 67 (see FIG. 19), or both.

The program storage 30 stores programs that are executable to perform the functions of the buried pipe deterioration degree prediction apparatus 1. The programs that are executable to perform the functions of the buried pipe deterioration degree prediction apparatus 1 include, for example, a burial environment classification map creation program 31, a buried pipe deterioration degree prediction program 32, and a correspondence table creation program 33.

With reference to FIGS. 2 and 3, the correspondence table creator 90 creates a correspondence table 46 (see FIG. 9) based on the survey pipe data 40 (see FIG. 7) and the generally available geological map 42 (see FIG. 8). The correspondence table creator 90 is configured or programmed to include a corrosion rate calculator 91, a geological information acquirer 92, a ground ID assignor 93, a representative corrosion rate calculator 94, a burial environment classifier 95, a correspondence table generator 96, and a correspondence table output interface 97.

The corrosion rate calculator 91 calculates a corrosion rate of each survey pipe with a survey number (see FIG. 7). For example, the corrosion rate calculator 91 calculates a difference between the survey year (see FIG. 7) and the installation year of each survey pipe (see FIG. 7) as the burial period of each survey pipe. The corrosion rate calculator 91 calculates the corrosion rate of each survey pipe by dividing the corrosion depth of each survey pipe (see FIG. 7) by the burial period of the same survey pipe.

The geological acquirer information 92 acquires geological information for the survey site (see FIG. 7) with reference to the survey pipe data 40 (see FIG. 7) and the geological map database 22. The ground ID assignor 93 assigns a ground ID to the corresponding geological information (such as a combination of the ground surface geological features and the topography).

The representative corrosion rate calculator 94 calculates a representative corrosion rate for each ground ID. The representative corrosion rate for each ground ID is, for example, an average corrosion rate for each ground ID or a median corrosion rate for each ground ID. When the representative corrosion rate for each ground ID is the average corrosion rate for each ground ID, the representative corrosion rate calculator 94 calculates an average value of the corrosion rates for the survey pipes to which the same ground ID is assigned. When the representative corrosion rate for each ground ID is the median corrosion rate for each ground ID, the representative corrosion rate calculator 94 calculates a 50th percentile value of the corrosion rates of the survey pipes to which the same ground ID is assigned, for example.

The burial environment classifier 95 classifies the survey pipe data 40 into four burial environments A to D based on the type of soil (see FIG. 7) and the soil resistivity (see FIG. 7). The correspondence table generator 96 creates a correspondence table 46 (see FIG. 9) by associating the geological information, the ground ID, the representative corrosion rate, and the burial environment with each other. The correspondence table output interface 97 outputs the correspondence table 46 to the correspondence table storage 23 (see FIG. 6).

With reference to FIG. 2, the buried pipe data receiver 99 receives the buried pipe data 50 (see FIGS. 11 and 12) and the water leakage accident data 53 (see FIG. 13) from a client. The buried pipe data 50 and the water leakage accident data 53 are provided from the client, for example, through the storage medium 18 (see FIG. 1) or a communication network such as the Internet or an intranet. The buried pipe data receiver 99 outputs the buried pipe data 50 and the water leakage accident data 53 to the buried pipe data storage 24 (see FIG. 6). The buried pipe data 50 and the water leakage accident data 53 may be stored in the storage 19 (see FIG. 1) in advance.

With reference to FIG. 2, the map creator 100 includes a first map creator 101 and a second map creator 102.

With reference to FIG. 2, the first map creator 101 creates the general integrated map 56 (see FIG. 14) based on the pipeline map 51 (see FIG. 11), the geological map 42 (see FIG. 8), and the correspondence table 46 (see FIG. 9).

Specifically, the first map creator 101 reads the pipeline map 51 (see FIG. 11) from the buried pipe data storage 24 (see FIG. 6). The first map creator 101 reads the geological map 42 (for example, the subsurface geological map 43 and the topography classification map 44) for the region corresponding to the pipeline map 51 from the geological map database 22 (see FIGS. 6 and 8). The first map creator 101 reads the correspondence table 46 (see FIG. 9) from the correspondence table storage 23. The first map creator 101 creates the general integrated map 56 (see FIG. 14) by superimposing the burial environment and the ground ID for the region corresponding to the pipeline map 51 on the pipeline map 51.

The general integrated map 56 is a map in which the pipeline map 51, the general burial environment classification map 56a for the region corresponding to the pipeline map 51, and the ground ID map 56b for the region corresponding to the pipeline map 51 are combined. The general burial environment classification map 56a is a map indicating a burial environment for a region corresponding to the pipeline map 51. The ground ID map 56b is a map indicating a ground ID for the region corresponding to the pipeline map 51. The first map creator 101 outputs the general integrated map 56 to the map storage 25 (see FIG. 6).

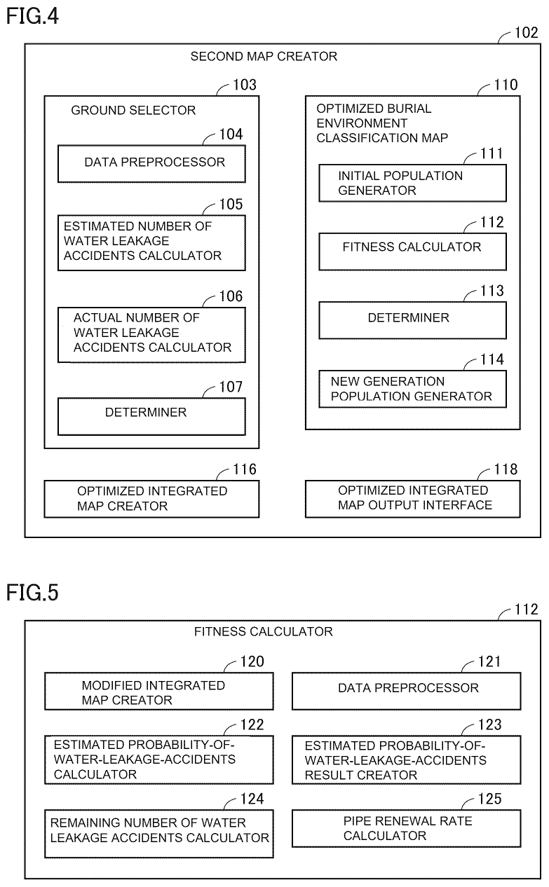

With reference to FIGS. 2 and 4, the second map creator 102 creates an optimized integrated map 58 (see FIG. 15) for the region corresponding to the pipeline map 51 by optimizing the burial environment classification of the general integrated map 56 (general burial environment classification map 56a). The second map creator 102 includes a ground selector 103, an optimized burial environment classification map creator 110, an optimized integrated map creator 116, and an optimized integrated map output interface 118.

With reference to FIG. 4, the ground selector 103 selects a ground ID as a candidate for optimizing the burial environment classification from all the ground IDs included in the general integrated map 56. With reference to FIG. 4, the ground selector 103 includes a data preprocessor 104, an estimated number of water leakage accidents calculator 105, an actual number of water leakage accidents calculator 106, and a determiner 107.

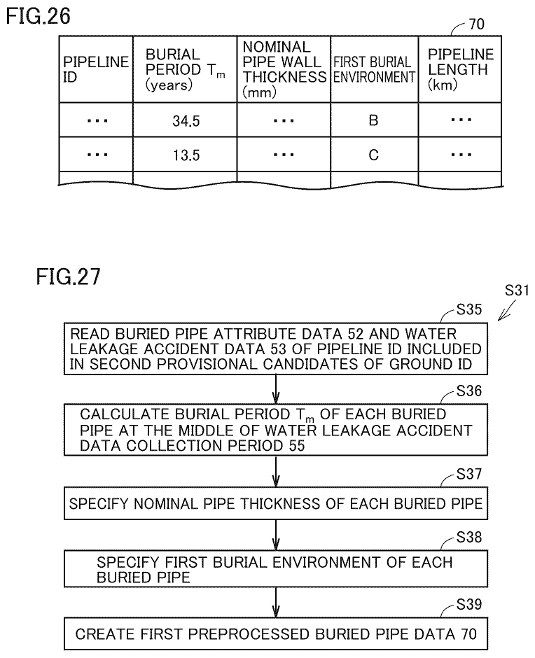

The data preprocessor 104 (see FIG. 4) creates first preprocessed buried pipe data 70 (see FIG. 26) based on the general integrated map 56 (see FIG. 14), the buried pipe data 50 (see FIGS. 11 and 12), and the water leakage accident data 53 (see FIG. 13).

With reference to FIG. 4, the estimated number of water leakage accidents calculator 105 calculates an estimated number of water leakage accidents per unit time during the water leakage accident data collection period 55 (see FIG. 13) for each second provisional candidate of the ground ID to be described later. The estimated number of water leakage accidents per unit time refers to an estimated number of water leakage accidents occurred in each second provisional candidate of the ground ID per unit time. For example, the unit time is one year, and the unit for the estimated number of water leakage accidents is case/year.

With reference to FIG. 4, the actual number of water leakage accidents calculator 106 calculates an actual number of water leakage accidents per unit time during the water leakage accident data collection period 55 (see FIG. 13) for each second provisional candidate of the ground ID to be described later. For example, the unit time is one year, the actual number of water leakage accidents per unit time is an annual average of the actual number of water leakage accidents occurred second provisional candidate of the ground ID during the water leakage accident data collection period 55, and the unit for the actual number of water leakage accidents per unit time is case/year.

With reference to FIG. 4, the determiner 107 determines whether or not the difference between the estimated number of water leakage accidents and the actual number of water leakage accidents is equal to or less than a reference value for each second provisional candidate of the ground ID to be described later. The determiner 107 excludes a ground ID with a difference that is equal to or less than the reference value from the second provisional candidates of the ground ID. The determiner 107 leaves a ground ID with a difference that is greater than the reference value in the second provisional candidates of the ground ID.

With reference to FIG. 4, the optimized burial environment classification map creator 110 creates the optimized burial environment classification map 58a by optimizing a burial environment classification of the ground ID selected by the ground selector 103 by machine learning. With reference to FIG. 4, the optimized burial environment classification map creator 110 is configured or programmed to include an initial population generator 111, a fitness calculator 112, a determiner 113, and a new generation population generator 114.

The initial population generator 111 randomly changes the burial environment classification of the ground ID selected by the ground selector 103 from the general burial environment classification map 56a to generate an initial population that includes a plurality of burial environment classification map candidates. The entirety of the plurality of burial environment classification map candidates is referred to as a “population”.

The fitness calculator 112 calculates fitness for each individual of an initial population or a new generation population (hereinafter, the initial population and the new generation population are collectively referred to as the “current generation population”). The “individual” refers to each of a plurality of burial environment map candidates of the current generation population. The individual includes a plurality of genes. As illustrated in FIG. 29, for example, each of the plurality of genes refers to the number of steps to change the burial environment classification of the ground ID selected in step S21. With reference to FIG. 5, the fitness calculator 112 includes a modified integrated map creator 120, a data preprocessor 121, an estimated probability-of-water-leakage-accidents calculator 122, an estimated probability-of-water-leakage-accidents result creator 123, a remaining number of water leakage accidents calculator 124, and a pipe renewal rate calculator 125.

With reference to FIG. 5, the modified integrated map creator 120 creates a modified integrated map corresponding to an individual (step S50). Specifically, the modified integrated map creator 120 changes the burial environment classification of a ground ID corresponding to a non-zero gene included in the individual among the ground IDs included in the general integrated map 56 (general burial environment classification map 56a) by the number of steps to change the burial environment classification expressed by the non-zero gene. Thus, a modified integrated map corresponding to the individual is created.

With reference to FIG. 5, the data preprocessor 121 creates second preprocessed buried pipe data 74 (see FIG. 32) based on the modified integrated map, the buried pipe attribute data 52 (see FIG. 12), and the water leakage accident data 53 (see FIG. 13).

With reference to FIG. 5, the estimated probability-of-water-leakage-accidents calculator 122 calculates an estimated probability of water leakage accidents of the buried pipe for each pipeline ID included in the modified integrated map. Specifically, the estimated probability-of-water-leakage-accidents calculator 122 reads a pipeline ID, and a modified burial environment and a nominal pipe wall thickness corresponding to the pipeline ID from the second preprocessed buried pipe data 74 (see FIG. 32). The estimated probability-of-water-leakage-accidents calculator 122 selects, from a plurality of probability-of-water-leakage-accidents prediction models 28 (see FIG. 6) stored in the probability-of-water-leakage-accidents prediction model storage 27 (see FIG. 6), a probability-of-water-leakage-accidents prediction model 28 suitable for the read modified burial environment and the read nominal pipe wall thickness.

The estimated probability-of-water-leakage-accidents calculator 122 reads a pipeline ID and a burial period Tₘ corresponding to the pipeline ID from the second preprocessed buried pipe data 74. The estimated probability-of-water-leakage-accidents calculator 122 inputs the burial period Tₘ to the selected probability-of-water-leakage-accidents prediction model 28 to calculate an estimated probability of water leakage accidents Rₘ at the middle of the water leakage accident data collection period 55 for each pipeline ID. The estimated probability of water leakage accidents refers to an estimated number of water leakage accidents occurred per unit time and per unit distance. The unit for the estimated probability of water leakage accidents Rₘ is, for example, case/year/km.

With reference to FIG. 5, the estimated probability-of-water-leakage-accidents result creator 123 creates an estimated probability-of-water-leakage-accidents result 76 (see FIG. 34) for each individual. Specifically, the estimated probability-of-water-leakage-accidents result creator 123 creates the estimated probability-of-water-leakage-accidents result 76 by associating the pipeline ID included in the modified integrated map, the estimated probability of water leakage accidents Rₘ, and the pipeline length (see FIG. 12) with each other.

With reference to FIG. 5, the remaining number of water leakage accidents calculator 124 calculates a remaining number of water leakage accidents by subtracting, from the total number of water leakage accidents included in the water leakage accident data 53, the number of water leakage accidents that could have been prevented from occurring if some of the pipeline IDs included in the estimated probability-of-water-leakage-accidents result 76 for each individual are renewed to new pipes in descending order of the estimated probability of water leakage accidents Rₘ from the beginning of the water leakage accident data collection period 55.

With reference to FIG. 5, the pipe renewal rate calculator 125 calculates a pipe renewal rate by dividing the pipe length renewed from the beginning of the water leakage accident data collection period 55 by the total pipe length of the pipeline ID included in the estimated probability-of-water-leakage-accidents result 76 for each individual.

With reference to FIG. 4, the determiner 113 performs a termination determination to terminate the generation of the new generation population. The determiner 113 determines whether or not a termination condition is satisfied. The termination condition is, for example, that individuals having the highest fitness in the population are the same for a predetermined number of consecutive generations (for example, 50 generations).

With reference to FIG. 4, if the termination condition is not satisfied, the new generation population generator 114 generates a new generation population.

With reference to FIG. 4, the optimized integrated map creator 116 combines the pipeline map 51, the optimized burial environment classification map 58a, and the ground ID map 56b to create an optimized integrated map 58 (see FIG. 15).

With reference to FIG. 4, the optimized integrated map output interface 118 outputs the optimized integrated map 58 to the map storage 25 (see FIG. 6). The optimized integrated map output interface 118 outputs the optimized integrated map 58 to at least one of the display 14 (see FIG. 1), the storage medium 18 (see FIG. 1), or the storage 19 (see FIG. 1).

With reference to FIG. 2, the buried pipe deterioration degree predictor 130 predicts a deterioration degree (for example, an estimated probability of water leakage accidents) for each buried pipe. The buried pipe deterioration degree predictor 130 includes a data preprocessor 131, a buried pipe deterioration degree calculator 132, a buried pipe deterioration degree prediction result creator 133, and a buried pipe deterioration degree prediction result output interface 134.

The data preprocessor 131 creates third preprocessed buried pipe data 78 (see FIG. 38) for each pipeline ID included in the optimized integrated map 58 based on the optimized integrated map 58 (see FIG. 15) and the buried pipe attribute data 52 (see FIG. 12).

The buried pipe deterioration degree calculator 132 calculates a deterioration degree for each pipeline ID included in the optimized integrated map 58. The deterioration degree is, for example, an estimated probability of water leakage accidents. The estimated probability of water leakage accidents refers to an estimated number of water leakage accidents occurred per unit time and per unit distance. The unit for the estimated probability of water leakage accidents is, for example, case/year/km.

The buried pipe deterioration degree prediction result creator 133 creates the buried pipe deterioration degree prediction result 65 (see FIGS. 18 and 19). The buried pipe deterioration degree prediction result 65 may be the buried pipe deterioration degree prediction table 66 (see FIG. 18), the buried pipe deterioration degree prediction map 67 (see FIG. 19), or both. In the buried pipe deterioration degree prediction map 67, the deterioration degree (for example, the probability of estimated water leakage accidents) for each buried pipe is illustrated in the map for each pipeline ID. In the buried pipe deterioration degree prediction table 66, the pipeline ID and the deterioration degree (for example, the estimated probability of water leakage accidents) are associated with each other.

The buried pipe deterioration degree prediction result output interface 134 (see FIG. 2) outputs the buried pipe deterioration degree prediction result 65 (see FIGS. 18 and 19) to the buried pipe deterioration degree prediction result storage 29 (see FIG. 6). The buried pipe deterioration degree prediction result output interface 134 outputs the buried pipe deterioration degree prediction result 65 to at least one of the display 14, the storage medium 18, or the storage 19 illustrated in FIG. 1.

A method of creating the correspondence table 46 will be described with reference to FIG. 20. The correspondence table 46 is created by the correspondence table creator 90.

The corrosion rate calculator 91 calculates the corrosion rate of a survey pipe for each survey number (step S1). Specifically, the corrosion rate calculator 91 reads the survey pipe data 40 (see FIG. 7) from the survey pipe data storage 21 (FIG. 6). The corrosion rate calculator 91 calculates a difference between the survey year (see FIG. 7) and the installation year of a survey pipe (see FIG. 7) as the burial period of the survey pipe. The corrosion rate calculator 91 calculates the corrosion rate of the survey pipe by dividing the corrosion depth of the survey pipe (see FIG. 7) by the burial period of the survey pipe.

The geological information acquirer 92 acquires geological information for the survey site (see FIG. 7) (step S2). Specifically, the geological information acquirer 92 reads the survey pipe data 40 (see FIG. 7) from the survey pipe data storage 21 (see FIG. 6) and reads the geological map 42 from the geological map database 22 (see FIG. 6). The geological information acquirer 92 refers to the survey pipe data 40 (see FIG. 7) and the geological map database 22 to acquire geological information for the survey site (see FIG. 7). The ground ID assignor 93 assigns a ground ID to the corresponding geological information (such as a combination of the ground surface geological features and the topography) (step S3).

The representative corrosion rate calculator 94 calculates a representative corrosion rate for each ground ID (step S4). The representative corrosion rate for each ground ID is, for example, an average corrosion rate for each ground ID or a median corrosion rate for each ground ID. When the representative corrosion rate for each ground ID is an average corrosion rate for each ground ID, the representative corrosion rate calculator 94 calculates an average value of the corrosion rates for the survey pipes to which the same ground ID is assigned. When the representative corrosion rate for each ground ID is a median corrosion rate for each ground ID, the representative corrosion rate calculator 94 calculates a 50th percentile value of the corrosion rates for the survey pipes to which the same ground ID is assigned.

The burial environment classifier 95 classifies the survey pipe data 40 into the burial environments A to D based on the type of soil (see FIG. 7) and the soil resistivity (see FIG. 7) (step S5). The correspondence table generator 96 creates the correspondence table 46 (see FIG. 9) by associating the geological information, the ground ID, the representative corrosion rate, and the burial environment with each other (step S6). The correspondence table output interface 97 outputs the correspondence table 46 to the correspondence table storage 23 (see FIG. 6) (step S7). The correspondence table 46 is stored in the correspondence table storage 23.

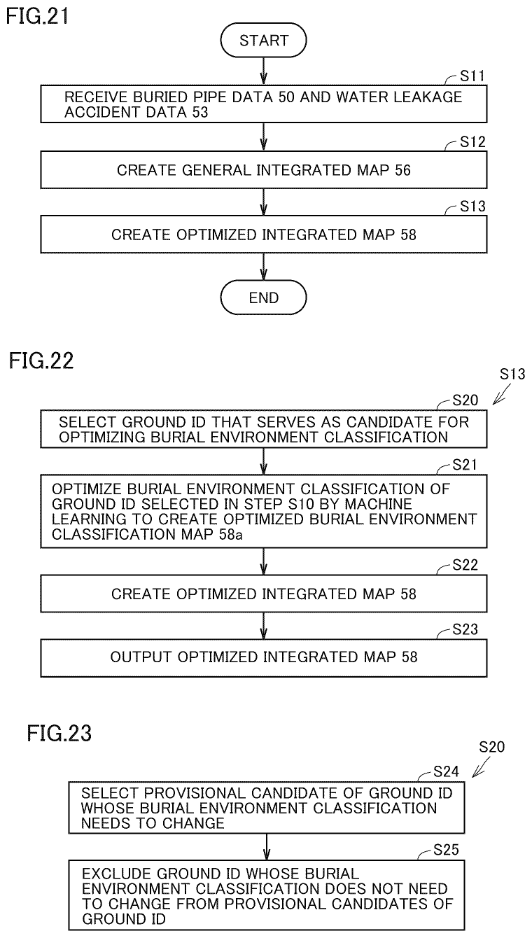

A method of creating the optimized integrated map 58 (see FIG. 15) that includes the optimized burial environment classification map 58a (see FIG. 15) will be described with reference to FIGS. 21 to 35. The method of creating the optimized integrated map 58 is performed by the buried pipe data receiver 99 (see FIG. 2) and the map creator 100 (see FIG. 2).

With reference to FIG. 21, the method of creating optimized burial environment classification map 58a according to the present example embodiment includes a step of receiving buried pipe data 50 (see FIGS. 11 and 12) and water leakage accident data 53 (see FIG. 13) from a client (step S11), a step of creating a general integrated map 56 (see FIG. 14) (step S12), and a step of creating an optimized integrated map 58 (see FIG. 15) (step S13).

With reference to FIG. 21, the buried pipe data receiver 99 (see FIG. 2) receives a buried pipe data 50 (see FIGS. 11 and 12) and a water leakage accident data 53 (see FIG. 13) from a client (step S11). The buried pipe data 50 includes, for example, a pipeline map 51 (see FIG. 11) and buried pipe attribute data 52 (see FIG. 12). The buried pipe data receiver 99 outputs the buried pipe data 50 and the water leakage accident data 53 to the buried pipe data storage 24 (see FIG. 6). The buried pipe data 50 and the water leakage accident data 53 are stored in the buried pipe data storage 24.

With reference to FIG. 21, the first map creator 101 (see FIG. 2) creates a general integrated map 56 (see FIG. 14) (step S12).

Specifically, the first map creator 101 reads the pipeline map 51 (see FIG. 11) from the buried pipe data storage 24 (see FIG. 6). The first map creator 101 reads the geological map 42 (for example, the subsurface geological map 43 and the topography classification map 44) for the region corresponding to the pipeline map 51 from the geological map database 22 (see FIGS. 6 and 8). The first map creator 101 reads the correspondence table 46 (see FIG. 9) from the correspondence table storage 23. The first map creator 101 creates the general integrated map 56 (see FIG. 14) by superimposing the burial environment and the ground ID for the region corresponding to the pipeline map 51 on the pipeline map 51.

The general integrated map 56 is a map in which the pipeline map 51, the general burial environment classification map 56a for the region corresponding to the pipeline map 51, and the ground ID map 56b for the region corresponding to the pipeline map 51 are combined. The general burial environment classification map 56a is a map indicating a burial environment for a region corresponding to the pipeline map 51. The ground ID map 56b is a map indicating a ground ID for a region corresponding to the pipeline map 51. The first map creator 101 outputs the general integrated map 56 (see FIG. 14) to the map storage 25. The general integrated map 56 is stored in the map storage 25.

With reference to FIG. 21, the second map creator 102 (see FIG. 2) creates an optimized integrated map 58 (see FIG. 15) by optimizing the burial environment classification of the general integrated map 56 (general burial environment classification map 56a) based on the water leakage accident data 53 (step S13).

Step S13 will be described in detail with reference to FIG. 22. Step S13 includes a step of selecting a ground ID that serves as a candidate for optimizing the burial environment classification from all the ground IDs included in the general burial environment classification map 56a (step S20), a step of creating an optimized burial environment classification map 58a by optimizing the burial environment classification of the ground ID selected in step S20 by machine learning (step S21), a step of creating an optimized integrated map 58 (step S22), and a step of outputting the optimized integrated map 58 (step S23).

Step S20 will be described in detail with reference to FIG. 23.

The second map creator 102 (see FIG. 2) reads the general integrated map 56 from the map storage 25 (see FIG. 6). The ground selector 103 (see FIG. 4) selects a provisional candidate of a ground ID with a burial environment classification that needs to change from all the ground IDs included in the general integrated map 56 (general burial environment classification map 56a) (step S24).

For example, in a case where no water leakage accident is recorded in the water leakage accident data 53 (see FIG. 13) during the water leakage accident data collection period 55 (see FIG. 13) in a ground ID which is assigned a burial environment classification (for example, the burial environment A or the burial environment B) illustrating a relatively high corrosivity in the general integrated map (general 56 burial environment classification map 56a), it is necessary to change the burial environment classification of the ground ID to a burial environment classification having a lower corrosivity to the buried pipe (for example, the burial environment C or the burial environment D). Therefore, the ground selector 103 (see FIG. 4) refers to the general integrated 56 map (general burial environment classification map 56a) and the water leakage accident data 53 to select, from the ground IDs each of which is assigned a burial environment classification (for example, the burial environment A or the burial environment B) indicating a relatively high corrosivity in the general integrated map 56 (general burial environment classification map 56a), a ground ID which is recorded with no water leakage accident in the water leakage accident data 53 during the water leakage accident data collection period 55 as the first provisional candidate of the ground ID with a burial environment classification that needs to change.

The burial environment classification indicating a relatively high corrosivity refers to a burial environment classification indicating a higher corrosivity than a burial environment classification (for example, the burial environment D) indicating the lowest corrosivity among a plurality of burial environment classifications (for example, the burial environment classifications A to D). The burial environment classification indicating a relatively high corrosivity includes, for example, a burial environment classification (for example, the burial a environment A) indicating the highest corrosivity among plurality of burial environment classifications (for example, the burial environment classifications A-D) and a burial environment classification (for example, the burial environment B) indicating a second highest corrosivity among a plurality of burial environment classifications (for example, the burial environment classifications A-D).

On the other hand, in a case where a water leakage accident is recorded in the water leakage accident data 53 (see FIG. 13) during the water leakage accident data collection period 55 (see FIG. 13) in a ground ID which is assigned a burial environment classification (for example, the burial environment B, the burial environment C, or the burial environment D) indicating a relatively low corrosivity on the general integrated map 56 (general burial environment classification map 56a), it is necessary to change the burial environment classification of the ground ID to a burial environment classification (for example, the burial environment A or the like) having a higher corrosivity to the buried pipe. Therefore, the ground selector 103 (see FIG. 4) refers to the general integrated map 56 (general burial environment classification map 56a) and the water leakage accident data 53 to select, from the ground IDs each of which is assigned a burial environment classification (for example, the burial environment B, the burial environment C, or the burial environment D) indicating a relatively low corrosivity on the general integrated map 56 (general burial environment classification map 56a), a ground ID which is recorded with a water leakage accident in the water leakage accident data 53 during the water leakage accident data collection period 55 as the second provisional candidate of the ground ID with a burial environment classification that needs to change.

The burial environment classification indicating a relatively low corrosivity refers to a burial environment classification indicating a lower corrosivity than a burial environment classification (for example, the burial environment A) indicating the highest corrosivity among a plurality of burial environment classifications (for example, the burial environment classifications A to D). The burial environment classification indicating a relatively low corrosivity includes, for example, a burial environment classification (for example, the burial environment D) indicating the lowest corrosivity among a plurality of burial environment classifications (for example, the burial environment classifications A-D), a burial environment classification (for example, the burial environment C) indicating a second lowest corrosivity among a plurality of burial environment classifications (for example, the burial environment classifications A-D), and a burial environment classification (for example, the burial environment B) indicating the third lowest corrosivity among a plurality of burial environment classifications (for example, the burial environment classifications A-D).

With reference to FIG. 23, the ground selector 103 (see FIG. 4) excludes a ground ID with a burial environment classification that does not need to change from the provisional candidates of the ground ID (step S25). For example, even in the case of the ground ID which is assigned a burial environment classification (e.g., the burial environment A) indicating a relatively high corrosivity on the general integrated map 56 (general burial environment classification map 56a) but is recorded with no water leakage accident in the water leakage accident data 53 (see FIG. 13) during the water leakage accident data collection period 55 (see FIG. 13), it is not necessary to change the burial environment classification for the ground ID which has a high corrosivity to the buried pipe. Therefore, the ground selector 103 refers to the general integrated map 56 (general burial environment classification map 56a) and the correspondence table 46 (see FIG. 9), and excludes the ground ID with a representative corrosion rate that is equal to or higher than the reference corrosion rate from the first provisional candidates of the ground ID as the ground ID which has a high corrosivity to the buried pipe.

In addition, it is also not necessary to change the burial environment classification of a ground ID for which the difference between the estimated number of water leakage accidents per unit time during the water leakage accident data collection period 55 (see FIG. 13) calculated by the probability-of-water-leakage-accidents prediction model 28 and the actual number of water leakage accidents per unit time during the water leakage accident data collection period 55 obtained from the water leakage accident data 53 is equal to or less than the reference value. Therefore, the ground selector 103 (see FIG. 4) excludes, from the second provisional candidates of the ground ID, the ground ID for which the difference between the estimated number of water leakage accidents per unit time during the water leakage accident data collection period 55 calculated by the probability-of-water-leakage-accidents prediction model 28 and the actual number of water leakage accidents per unit time during the water leakage accident data collection period 55 obtained from the water leakage accident data 53 is equal to or less than the reference value.

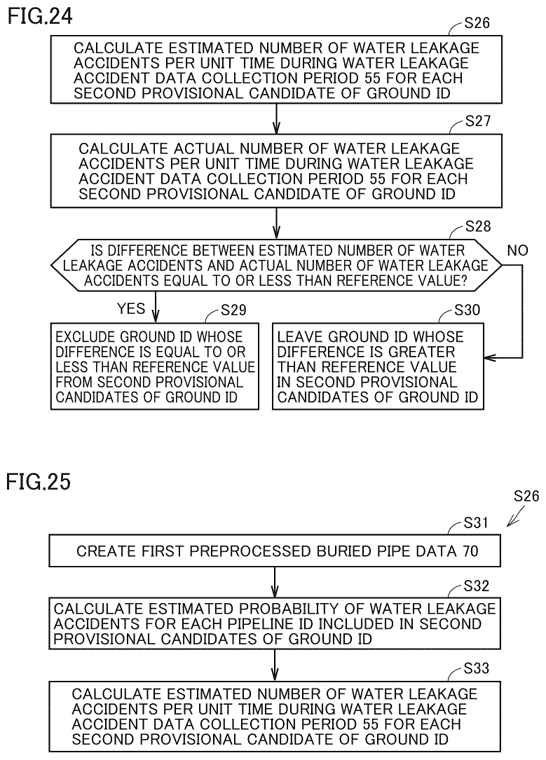

Specifically, with reference to FIG. 24, the estimated number of water leakage accidents calculator 105 (see FIG. 4) calculates the estimated number of water leakage accidents per unit time during the water leakage accident data collection period 55 for each second provisional candidate of the ground ID based on the probability-of-water-leakage-accidents prediction model 28 (see FIG. 6 and FIG. 17) and the general integrated map 56 (see FIG. 14) (step S26). Step S26 will be described in detail with reference to FIG. 25.

The data preprocessor 104 (see FIG. 4) creates first preprocessed buried pipe data 70 (see FIG. 26) for each pipeline ID included in the second provisional candidates of the ground ID based on the second provisional candidates of the ground ID, the general integrated map 56 (see FIG. 14), the buried pipe data 50 (see FIGS. 11 and 12), and the water leakage accident data 53 (see FIG. 13) (step S31). Step S31 will be described in detail with reference to FIG. 27.

The data preprocessor 104 refers to the second provisional candidates of the ground ID, and reads the buried pipe attribute data 52 (see FIG. 12) and the water leakage accident data 53 (see FIG. 13) of a pipeline ID included in the second provisional candidates of the ground ID from the buried pipe data storage 24 (see FIG. 6) (step S35).

The data preprocessor 104 (see FIG. 4) calculates, for each pipeline ID included in the second provisional candidates of the ground ID, a burial period Tₘ of a buried pipe at the middle between the beginning and the end of the water leakage accident data collection period 55 (see FIG. 13) (step S36). Specifically, the data preprocessor 104 calculates the middle of the water leakage accident data collection period 55 by dividing the sum of the beginning of the water leakage accident data collection period 55 and the end of the water leakage accident data collection period 55 by two. The data preprocessor 104 calculates, for each pipeline ID included in the second provisional candidates of the ground ID, a difference between the middle of the water leakage accident data collection period 55 and the installation year of the buried pipe (see FIG. 12) as the burial period Tₘ of the buried pipe at the middle of the water leakage accident data collection period 55.

The data preprocessor 104 specifies the nominal pipe wall thickness of the buried pipe for each pipeline ID included in the second provisional candidates of the ground ID (step S37). Specifically, the data preprocessor 104 reads the nominal pipe wall thickness data 60 (see FIG. 16) from the nominal pipe wall thickness database 26 (see FIG. 6). The data preprocessor 104 refers to the installation year, the nominal diameter, the type of joint, and the type of pipe wall thickness (see FIG. 12) of the buried pipe attribute data 52 and the nominal pipe wall thickness data 60 to determine the nominal pipe wall thickness of the buried pipe for each pipeline ID included in the second provisional candidates of the ground ID.

The data preprocessor 104 refers to the second provisional candidates of the ground ID and the general integrated map 56 (see FIG. 14) to specify a burial environment (hereinafter referred to as a “first burial environment”) of the buried pipe for each pipeline ID included in the second provisional candidates of the ground ID (step S38).

The data preprocessor 104 combines the pipeline ID, the burial period Tₘ, the nominal pipe wall thickness, the first burial environment, and the pipeline length (see FIG. 12) to create the first preprocessed buried pipe data 70 (see FIG. 26) for each pipeline ID included in the second provisional candidates of the ground ID (step S39).

With reference to FIG. 25, the estimated number of water leakage accidents calculator 105 (see FIG. 4) calculates an estimated probability of water leakage accidents Rₘ of the buried pipe for each pipeline ID included in the second provisional candidates of the ground ID (step S32).

Specifically, the estimated number of water leakage accidents calculator 105 reads a pipeline ID, and the first burial environment and the nominal pipe wall thickness corresponding to the pipeline ID from the first preprocessed buried pipe data 70. The estimated number of water leakage accidents calculator 105 selects, from a plurality of probability-of-water-leakage-accidents prediction models 28 stored in the probability-of-water-leakage-accidents prediction model storage 27, a probability-of-water-leakage-accidents prediction model 28 suitable for the read first burial environment and nominal pipe wall thickness. For example, when the read first burial environment is the burial environment B and the read nominal pipe wall thickness is about 7.5 mm, the curve of the burial environment B in FIG. 17 represents the leakage accident rate prediction model 28 suitable for the read first burial environment and the read nominal pipe wall thickness.

The estimated number of water leakage accidents calculator 105 reads a pipeline ID and a burial period Tₘ corresponding to the pipeline ID from the first preprocessed buried pipe data 70. The estimated number of water leakage accidents calculator 105 inputs the burial period Tₘ to the selected probability-of-water-leakage-accidents prediction model 28 to calculate an estimated probability of water leakage accidents Rₘ at the middle of the water leakage accident data collection period 55 for each pipeline ID (see FIG. 17). The unit for the estimated probability of water leakage accidents Rₘ is, for example, case/year/km.

With reference to FIG. 25, the estimated number of water leakage accidents calculator 105 (see FIG. 4) calculates the estimated number of water leakage accidents per unit time during the water leakage accident data collection period 55 for each second provisional candidate of the ground ID (step S33). For example, the unit time is one year, and the unit for the estimated number of water leakage accidents is case/year. Specifically, the estimated number of water leakage accidents calculator 105 reads, from the first preprocessed buried pipe data 70 (see FIG. 26), a pipeline ID included in the second provisional candidates of the ground ID and a pipeline length corresponding to the pipeline ID. The estimated number of water leakage accidents calculator 105 calculates the product of the estimated probability of water leakage accidents Rₘ for each pipeline ID and the pipeline length for each pipeline ID. The estimated number of water leakage accidents calculator 105 calculates the sum of the products for each second provisional candidate of the ground ID. Thus, the estimated number of water leakage accidents calculator 105 calculates the estimated water leakage accident number per unit time during the water leakage accident data collection period 55 for each second provisional candidate of the ground ID.

With reference to FIG. 24, the actual number of water leakage accidents calculator 106 (see FIG. 4) calculates an actual number of water leakage accidents per unit time during the water leakage accident data collection period 55 for each second provisional candidate of the ground ID with reference to the general integrated map 56 and the water leakage accident data 53 (step S27). For example, the unit time is one year, the actual number of water leakage accidents per unit time refers to an annual average of the actual number of water leakage accidents occurred in each ground ID during the water leakage accident data collection period 55, and the unit for the actual number of water leakage accidents per unit time is case/year.

Specifically, the actual number of water leakage accidents calculator 106 calculates the actual number of water leakage accidents occurred during the water leakage accident data collection period 55 for each second provisional candidate of the ground ID with reference to the second provisional candidates of the ground ID and the water leakage accident data 53. The actual number of water leakage accidents calculator 106 divides the actual number of water leakage accidents for each ground ID occurred during the water leakage accident data collection period 55 by the water leakage accident data collection period 55. Thus, the actual number of water leakage accidents calculator 106 calculates the actual number of water leakage accidents per unit time during the water leakage accident data collection period 55 for each second provisional candidate of the ground ID.

With reference to FIG. 24, the determiner 107 (see FIG. 4) determines, for each second provisional candidate of the ground ID, whether or not the difference between the estimated number of water leakage accidents calculated in step S26 and the actual number of water leakage accidents calculated in step S27 is equal to or less than a reference value (step S28). The determiner 107 excludes the ground ID with a difference that is equal to or less than the reference value from the second provisional candidates of the ground ID (step S29). The determiner 107 leaves the ground ID with a difference that is greater than the reference value in the second provisional candidate of the ground ID (step S30). Thus, the ground selector 103 selects a ground ID as the candidate for optimizing the burial environment classification from all the ground IDs included in the general integrated map 56.

With reference to FIG. 22, step S21 is performed by the optimized burial environment classification map creator 110. Step S21 will be described in detail with reference to FIGS. 22 and 28 to 35. As an example of the machine learning in step S21, an evolutionary calculation method such as a genetic algorithm, an evolutionary algorithm or swarm intelligence, a greedy method, a nearest neighbor search method, a local search method, a mathematical optimization method, or the like may be used. Thus, an optimized burial environment classification map 58a (see FIG. 15) that reflects the optimized burial environment classification is created. As an example method, a genetic algorithm is used to create the optimized burial environment classification map 58a.

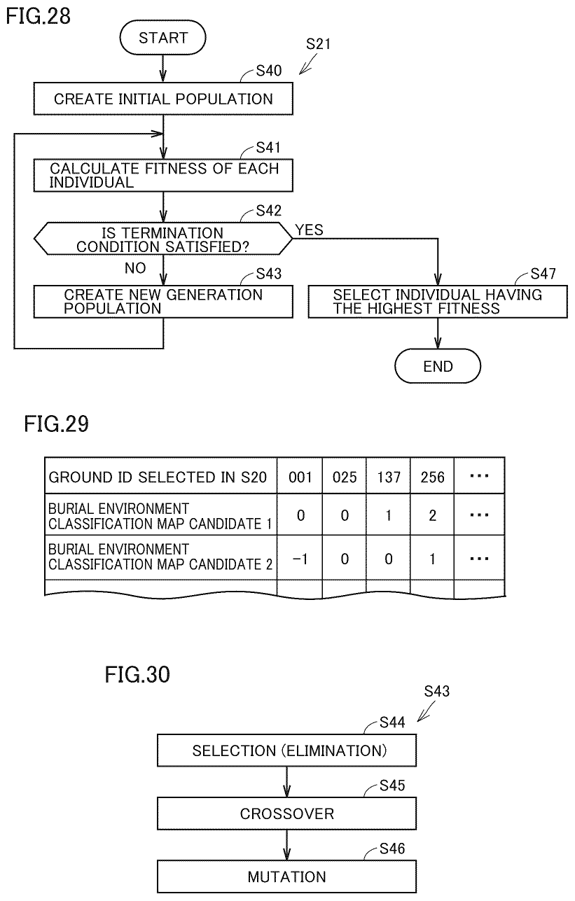

With reference to FIG. 28, the initial population generator 111 changes randomly the burial environment classification of the ground ID selected from the general burial environment classification map 56a in step S20 (see FIG. 22) to generate an initial population including a plurality of burial environment classification map candidates (step S40). Each of the plurality of burial environment map candidates is referred to as an “individual”. The individual includes a plurality of genes. As illustrated in FIG. 29, for example, each of the plurality of genes refers to the number of steps to change the burial environment classification of the ground ID selected in step S21.

Specifically, when the burial environment classification of a certain ground ID is changed from the burial environment B to the burial environment A, in other words, when the burial environment classification of the certain ground ID is changed to a burial environment classification having a higher corrosivity to the buried pipe by one rank, it is expressed as a gene of 1. When the burial environment classification of a certain ground ID is changed to a burial environment classification having a lower corrosivity to the buried pipe by one rank, in other words, when the burial environment classification of the certain ground ID is changed from the burial environment C to the burial environment D, it is expressed as a gene of −1. When the burial environment classification of a certain ground ID is changed to a burial environment classification having a higher corrosivity to the buried pipe by two ranks, in other words, when the burial environment classification of the certain ground ID is changed from the burial environment C to the burial environment A, it is expressed as a gene of 2. When the burial environment classification of a certain ground ID is changed to a burial environment classification having a lower corrosivity to the buried pipe by two ranks, in other words, when the burial environment classification of the certain ground ID is changed from the burial environment B to the burial environment D, it is expressed as a gene of −2.

With reference to FIG. 28, the fitness calculator 112 (see FIG. 4) calculates fitness for each individual of the initial population generated in step S40 or the new generation population generated in step S43 (hereinafter, the initial population and the new generation population are collectively referred to as the “current generation population”) (step S41). Example fitness will be described later.

The determiner 113 (see FIG. 4) performs a termination determination to terminate the generation of a new generation population. The determiner 113 determines whether or not a termination condition is satisfied (step S42). The termination condition is, for example, that individuals having the highest fitness in the population are the same for a predetermined number of consecutive generations (for example, 50 generations).

If the termination condition is not satisfied in step S42, the new generation population generator 114 generates a new generation population (step S43). As an example, step S43 will be described with reference to FIG. 30.

In step S44, the new generation population generator 114 (see FIG. 4) selects a plurality of individuals from the current generation population as parents for the next generation. For example, the new generation population generator 114 selects those individuals having high fitness from the individuals of the current generation population, and eliminates (deletes) those individuals having low fitness from the individuals of the current generation population (elite strategy).

In step S45, the new generation population generator 114 (see FIG. 4) selects two individuals from the individuals selected in step S44, and performs a crossover process to swap genes between the two individuals. Thus, new individuals with recombined genes are generated. The number of individuals generated in step S45 is, for example, equal to the number of individuals eliminated (deleted) in step S44. Thus, the new generation population generator 114 generates a new population including the individuals selected in step S44 and the new individuals generated in step S45. For example, any known method such as a single-point crossover method, a multi-point crossover method, or a uniform crossover method can be used in the crossover process.

In step S46, the new generation population generator 114 (see FIG. 4) performs a mutation process to randomly swap genes with a predetermined probability on the individuals of the new population generated in step S45. Any known method can be used in the mutation process. Thus, a new generation population is created.

Then, the procedure returns to step S41 where the fitness calculator 112 (see FIG. 4) calculates the fitness of each individual of the new generation population. Steps S41 and S43 are repeated until the termination condition is satisfied in step S42.

If the termination condition is satisfied in step S42, the optimized burial environment classification map creator 110 (see FIG. 4) selects an individual having the highest fitness from the individuals of the current generation population (step S47). The optimized burial environment classification map creator 110 changes the burial environment classification of the ground ID corresponding to a non-zero gene included in the individual selected in step S47 from the ground IDs included in the general burial environment classification map 56a by the number of steps to change the burial environment classification expressed by the non-zero gene. Thus, an optimized burial environment classification map 58a (see FIG. 15) that reflects the optimized burial environment classification is created.

With reference to FIG. 22, the optimized integrated map creator 116 (see FIG. 4) combines the pipeline map 51, the optimized burial environment classification map 58a, and the ground ID map 56b to create an optimized integrated map 58 (see FIG. 15) (step S22). In step S23, the optimized integrated map output interface 118 (see FIG. 4) outputs the optimized integrated map 58 to the map storage 25 (see FIG. 6). The optimized integrated map 58 is stored in the map storage 25. The optimized integrated map output interface 118 outputs the optimized integrated map 58 to at least one of the display 14 (see FIG. 1), the storage medium 18 (see FIG. 1), or the storage 19 (see FIG. 1).

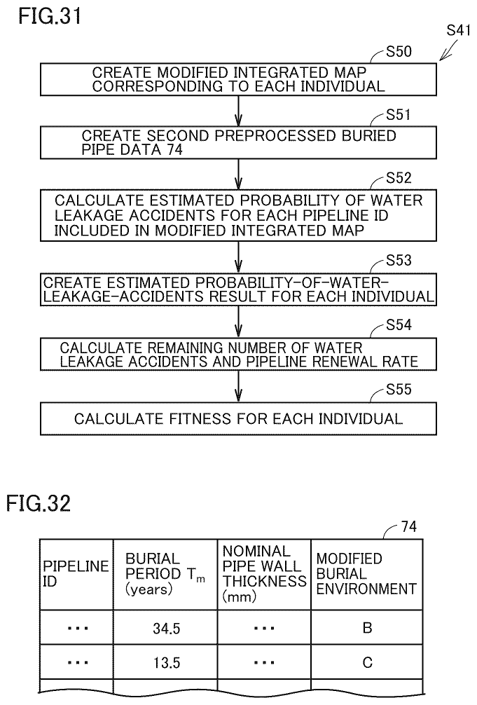

The step of calculating the fitness of each individual of the current generation population (step S41) will be described in detail with reference to FIGS. 31 to 35.

With reference to FIG. 31, the modified integrated map creator 120 (see FIG. 5) creates a modified integrated map for each individual (step S50). Specifically, the modified integrated map creator 120 changes the burial environment classification of the ground ID corresponding to a non-zero gene included in the individual among the ground IDs included in the general integrated map 56 by the number of steps to change the burial environment classification expressed by the non-zero gene. Thus, the modified integrated map is created for each individual.

With reference to FIG. 31, the data preprocessor 121 (see FIG. 5) creates second preprocessed buried pipe data 74 (see FIG. 32) for each pipeline ID included in the modified integrated map based on the modified integrated map, the buried pipe attribute data 52 (see FIG. 12), and the water leakage accident data 53 (see FIG. 13) (step S51). The second preprocessed buried pipe data 74 is created by the same method as the first preprocessed buried pipe data 70 (see FIG. 26), but is created based on the modified integrated map instead of the general integrated map (see FIG. 14). Therefore, the second preprocessed buried pipe data 74 includes the modified burial environment included in the modified integrated map instead of the first burial environment of the first preprocessed buried pipe data 70 (see FIG. 26).

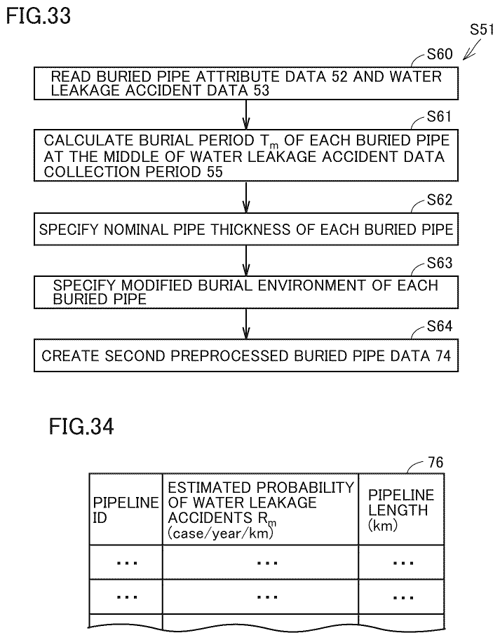

Specifically, with reference to FIG. 33, the data preprocessor 121 (see FIG. 5) refers to the modified integrated map, and reads the buried pipe attribute data 52 and the water leakage accident data 53 from the buried pipe data storage 24 (see FIG. 6) for the pipeline ID included in the modified integrated map (step S60).

The data preprocessor 121 (see FIG. 5) calculates, for each pipeline ID included in the modified integrated map, a burial period Tₘ of a buried pipe at the middle between the beginning and the end of the water leakage accident data collection period 55 (step S61). Specifically, the data preprocessor 121 calculates the middle of the water leakage accident data collection period 55 by dividing the sum of the beginning of the water leakage accident data collection period 55 and the end of the water leakage accident data collection period 55 by two. The data preprocessor 121 calculates, for each pipeline ID included in the modified integrated map, a difference between the middle of the water leakage accident data collection period 55 and the installation year of the buried pipe (see FIG. 12) as the burial period Tₘ of the buried pipe at the middle of the water leakage accident data collection period 55.

The data preprocessor 121 (see FIG. 5) specifies the nominal pipe wall thickness of the buried pipe for each pipeline modified ID included in the integrated map (step S62). Specifically, the data preprocessor 121 reads the nominal pipe wall thickness data 60 (see FIG. 16) from the nominal pipe wall thickness database 26 (see FIG. 6). The data preprocessor 121 refers to the installation year, the nominal diameter, the type of joint, and the type of pipe wall thickness (see FIG. 12) of the buried pipe attribute data 52 and the nominal pipe wall thickness data 60 to determine the nominal pipe wall thickness of the buried pipe for each pipeline ID included in the modified integrated map.

The data preprocessor 121 (see FIG. 5) refers to the modified integrated map to specify the modified burial environment of the buried pipe for each pipeline ID included in the modified integrated map (step S63).

The data preprocessor 121 (see FIG. 5) combines the pipeline ID, the burial period Tₘ, the nominal pipe wall thickness, and the modified burial environment to create the second preprocessed buried pipe data 74 (see FIG. 32) for each pipeline ID included in the modified integrated map (step S64).

With reference to FIG. 31, the estimated probability-of-water-leakage-accidents calculator 122 (see FIG. 5) calculates an estimated probability of water leakage accidents Rₘ for each pipeline ID included in the modified integrated map (step S52). Specifically, the estimated probability-of-water-leakage-accidents calculator 122 reads a pipeline ID, and the modified burial environment and the nominal pipe wall thickness corresponding to the pipeline ID from the second preprocessed buried pipe data 74 (see FIG. 32). The estimated probability-of-water-leakage-accidents calculator 122 selects, from a plurality of probability-of-water-leakage-accidents prediction models 28 (see FIG. 6) stored in the probability-of-water-leakage-accidents prediction model storage 27 (see FIG. 6), a probability-of-water-leakage-accidents prediction model 28 suitable for the read modified burial environment and nominal pipe wall thickness.

The estimated probability-of-water-leakage-accidents calculator 122 reads a pipeline ID and the burial period Tₘ corresponding to the pipeline ID from the second preprocessed buried pipe data 74. The estimated probability-of-water-leakage-accidents calculator 122 inputs the burial period Tₘ to the selected probability-of-water-leakage-accidents prediction model 28 to calculate an estimated probability of water leakage accidents Rₘ at the middle of the water leakage accident data collection period 55 for each pipeline ID. The unit for the estimated probability of water leakage accidents Rₘ is, for example, case/year/km.

With reference to FIG. 31, the estimated probability-of-water-leakage-accidents result creator 123 refers to the modified integrated map, and reads the pipe length (see FIG. 12) of the pipeline ID included in the modified integrated map from the buried pipe data storage 24 (see FIG. 6). The estimated probability-of-water-leakage-accidents result creator 123 associates the pipeline ID, the estimated probability of water leakage accidents Rₘ, and the pipeline length (see FIG. 12) with each other. Thus, the estimated probability-of-water-leakage-accidents result creator 123 creates the estimated probability-of-water-leakage-accidents result 76 (see FIG. 34) for each individual (step S53).

With reference to FIG. 31, with reference to the estimated probability-of-water-leakage-accidents result 76 (see FIG. 34) and the water leakage accident data 53 (see FIG. 13) for each individual, the remaining number of water leakage accidents when at least some of the pipeline IDs included in the estimated probability-of-water-leakage-accidents result 76 for each individual are renewed to new pipelines in descending order of the estimated probability of water leakage accidents Rₘ at the beginning of the water leakage accident data collection period 55, and a pipe renewal rate when at least some of the pipeline IDs included in the estimated probability-of-water-leakage-accidents result 76 for each individual are renewed to new pipelines in descending order of the estimated probability of water leakage accidents Rₘ at the beginning of the water leakage accident data collection period 55 are calculated (step S54). An example method of calculating the remaining number of water leakage accidents and the pipeline renewal rate will be described.

If some of the pipeline IDs included in the estimated probability-of-water-leakage-accidents result 76 (see FIG. 34) for each individual are renewed to new pipelines in descending order of the estimated probability of water leakage accidents Rₘ from the beginning of the water leakage accident data collection period 55 (see FIG. 13), the renewal of the pipelines can prevent the occurrence of a portion of the water leakage accidents included in the water leakage accident data 53.

Therefore, the remaining number of water leakage accidents calculator 124 (see FIG. 5) calculates the remaining number of water leakage accidents by subtracting, from the total number of water leakage accidents included in the water leakage accident data 53 (see FIG. 13), the number of water leakage accidents that can be prevented from occurring when some of the pipeline IDs included in the estimated probability-of-water-leakage-accidents result 76 for each individual are renewed to new pipelines in descending order of the estimated probability of water leakage accidents F from the beginning of the water leakage accident data collection period 55. The pipe renewal rate calculator 125 (see FIG. 5) calculates the pipe renewal rate by dividing the pipe length renewed from the beginning of the water leakage accident data collection period 55 by the total pipe length of the pipeline ID included in the estimated probability-of-water-leakage-accidents result 76 for each individual.

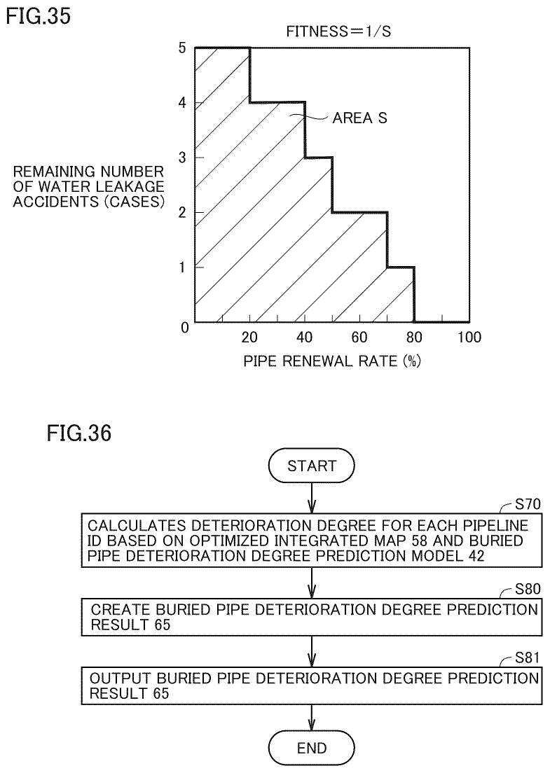

With reference to FIG. 31, the fitness calculator 112 (see FIG. 4) calculates fitness for each individual (step S55). Specifically, the fitness calculator 112 creates a graph (see FIG. 35) indicating a relationship between the pipeline renewal rate and the remaining number of water leakage accidents. The horizontal axis of the graph represents the pipeline renewal rate, and the vertical axis of the graph represents the remaining number of water leakage accidents. The smaller the area S (shaded area in FIG. 35) surrounded by the vertical axis, the horizontal axis and the line indicating the relationship between the pipeline renewal rate and the remaining number of water leakage accidents, the better the modified integrated map corresponding to an individual reflects the actual burial environment. Therefore, the fitness calculator 112 calculates the reciprocal of the area S as the fitness for each individual.

With reference to FIGS. 36 to 40, a buried pipe deterioration degree prediction method according to the present example embodiment will be described. The buried pipe deterioration degree prediction method is performed by the buried pipe deterioration degree predictor 130. An estimated probability of water leakage accidents will be described as an example of a deterioration degree for the buried pipe.

With reference to FIG. 36, the buried pipe deterioration degree predictor 130 calculates a deterioration degree (for example, an estimated probability of water leakage accidents) for each pipeline ID based on the optimized integrated map 58 (see FIG. 15) and the buried pipe deterioration degree prediction model (for example, the probability-of-water-leakage-accidents prediction model 28 (see FIGS. 6 and 40)) (step S70). The deterioration degree (for example, the estimated probability of water leakage accidents) calculated in step S70 may be a deterioration degree (for example, an estimated probability of water leakage accidents) for each pipeline ID in the current year, a deterioration degree (for example, an estimated probability of water leakage accidents) for each pipeline ID in a future year, or both. Step S70 will be described in detail.

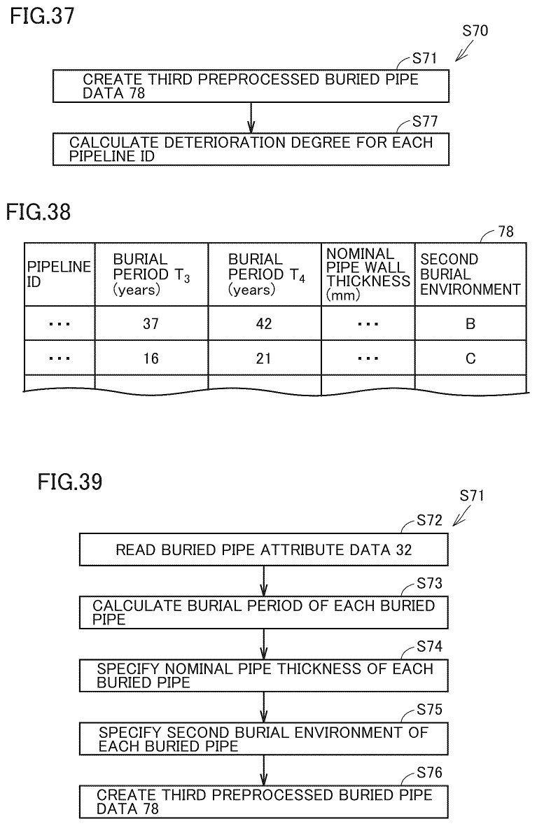

With reference to FIG. 37, the data preprocessor 131 (see FIG. 2) creates third preprocessed buried pipe data 78 (see FIG. 38) for each pipeline ID included in the optimized integrated map 58 based on the optimized integrated map 58 (see FIG. 15) and the buried pipe attribute data 52 (see FIG. 12) (step S71).

Specifically, with reference to FIG. 39, the data preprocessor 131 reads the optimized integrated map 58 from the map storage 25 (see FIG. 6). The data preprocessor 131 refers to the optimized integrated map 58, and reads the buried pipe attribute data 52 for each pipeline ID included in the optimized integrated map 58 from the buried pipe data storage 24 (see FIG. 6) (step S72).

The data preprocessor 131 (see FIG. 2) calculates a burial period of the buried pipe for each pipeline ID included in the optimized integrated map 58 (step S73). For example, in the case of calculating the estimated probability of water leakage accidents for each pipeline ID in the current year, the data preprocessor 131 calculates, for each pipeline ID included in the optimized integrated map 58, the difference between the current year and the installation year of the buried pipe (see FIG. 12) as a burial period T₃ of the buried pipe. In the case of calculating the estimated probability of water leakage accidents for each pipeline ID in a future year, the data preprocessor 131 calculates, for each pipeline ID included in the optimized integrated map 58, the difference between the future year and the installation year of the buried pipe (see FIG. 12) as a burial period T₄ of the buried pipe.

The data preprocessor 131 (see FIG. 2) specifies the nominal pipe wall thickness of the buried pipe for each pipeline ID included in the optimized integrated map 58 (step S74). Specifically, the data preprocessor 131 reads the nominal pipe wall thickness data 60 (see FIG. 16) from the nominal pipe wall thickness database 26 (see FIG. 6). The data preprocessor 131 refers to the installation year, the nominal diameter, the type of joint, and the type of pipe wall thickness (see FIG. 12) of the buried pipe attribute data 52 and the nominal pipe wall thickness data 60 to determine the nominal pipe wall thickness of the buried pipe for each pipeline ID included in the optimized integrated map 58.

The data preprocessor 131 (see FIG. 2) refers to the optimized integrated map 58 to specify the burial environment (second burial environment) of the buried pipe for each pipeline ID included in the optimized integrated map 58 (step S75).

The data preprocessor 131 (see FIG. 2) combines the pipeline ID, the burial period (for example, the burial period T₃ or the burial period T₄), the nominal pipe wall thickness, and the second burial environment to create the third preprocessed buried pipe data 78 (see FIG. 38) for each pipeline ID included in the optimized integrated map 58 (step S76).

With reference to FIG. 37, the buried pipe deterioration degree calculator 132 calculates a deterioration degree (for example, an estimated probability of water leakage accidents) for each pipeline ID included in the optimized integrated map 58 (step S77).

Specifically, the buried pipe deterioration degree calculator 132 reads a pipeline ID, and the second burial environment and the nominal pipe wall thickness corresponding to the pipeline ID from the third preprocessed buried pipe data 78 (see FIG. 38). The buried pipe deterioration degree calculator 132 selects, from a plurality of probability-of-water-leakage-accidents prediction models 28 (see FIGS. 6 and 40) stored in the probability-of-water-leakage-accidents prediction model storage 27, a probability-of-water-leakage-accidents prediction model 28 suitable for the read second burial environment and nominal pipe wall thickness. For example, when the read second burial environment is the burial environment B and the read nominal pipe wall thickness is about 7.5 mm, the curve of the burial environment B in FIG. 40 represents the leakage accident rate prediction model 28 suitable for the read second burial environment and the read nominal pipe wall thickness.

The buried pipe deterioration degree calculator 132 reads a pipeline ID and a burial period (for example, the burial period T₃ or the burial period T₄) corresponding to the pipeline ID from the third preprocessed buried pipe data 78 (see FIG. 38). The buried pipe deterioration degree calculator 132 inputs the burial period of the buried pipe (see FIG. 38) to the selected probability-of-water-leakage-accidents prediction model 28 to calculate a deterioration degree (for example, an estimated probability of water leakage accidents) for each pipeline ID (see FIG. 40). The estimated probability of water leakage accidents refers to an estimated number of water leakage accidents occurred per unit time and per unit distance. The unit for the estimated probability of water leakage accidents is, for example, case/year/km. The buried pipe deterioration degree calculator 132 may calculate a deterioration degree (for example, an estimated probability of water leakage accidents R₃) for each pipeline ID in the current year, may calculate a deterioration degree (for example, an estimated probability of water leakage accidents R₄) for each pipeline ID in a future year, or may calculate both.

The buried pipe deterioration degree prediction result creator 133 creates the buried pipe deterioration degree prediction result 65 (step S80). The buried pipe deterioration degree prediction result 65 may be the buried pipe deterioration degree prediction table 66 (see FIG. 18), the buried pipe deterioration degree prediction map 67 (see FIG. 19), or both.

Specifically, the buried pipe deterioration degree prediction result creator 133 associates the pipeline ID, the deterioration degree for the buried pipe (for example, the estimated probability of water leakage accidents), and the time (for example, the current year or the future year) at which the deterioration degree for the buried pipe is calculated with each other to create the buried pipe deterioration degree prediction table 66 (see FIG. 18). The buried pipe deterioration degree prediction result creator 133 reads the pipeline map 51 (see FIG. 11) from the buried pipe data storage 24 (see FIG. 6). The buried pipe deterioration degree prediction result creator 133 reflects in the pipeline map 51 the deterioration degree (for example, the estimated probability of water leakage accidents) of the buried pipe for each pipeline ID and the time (for example, the current year or the future year) at which the deterioration degree for the buried pipe is calculated to create a buried pipe deterioration degree prediction map 67 (see FIG. 19).

With reference to FIG. 36, in step S81, the buried pipe deterioration degree prediction result output interface 134 (see FIG. 2) outputs the buried pipe deterioration degree prediction result 65 to the buried pipe deterioration degree prediction result storage 29. The buried pipe deterioration degree prediction result 65 is stored in the buried pipe deterioration degree prediction result storage 29. The buried pipe deterioration degree prediction result output interface 134 (see FIG. 2) outputs the buried pipe deterioration degree prediction result 65 to at least one of the display 14, the storage medium 18, or the storage 19 illustrated in FIG. 1.

The burial environment classification map creation program 31 (see FIG. 6) causes the processor 12 (see FIG. 1) to execute the burial environment classification map creation method according to the present example embodiment. The map creator 100 (see FIG. 2) is implemented by causing the processor 12 to execute the burial environment classification map creation program 31.

The buried pipe deterioration degree prediction program 32 (see FIG. 6) causes the processor 12 (see FIG. 1) to execute the buried pipe deterioration degree prediction method according to the present example embodiment. The buried pipe deterioration degree predictor 130 (see FIG. 2) is implemented by causing the processor 12 to execute the buried pipe deterioration degree prediction program 32.

The correspondence table creation program 33 (see FIG. 6) causes the processor 12 (see FIG. 1) to execute the correspondence table creation method according to the present example embodiment. The correspondence table creator 90 (see FIG. 2) is implemented by causing the processor 12 to execute the correspondence table creation program 33.

The computer-readable recording medium (non-transitory computer-readable recording medium, for example, the storage medium 18) according to the present example embodiment may include recorded thereon programs such as the burial environment classification map creation program 31, the buried pipe deterioration degree prediction program 32, and the correspondence table creation program 33.

With reference to FIG. 41, according to a modification of the present example embodiment, the functions of the buried pipe deterioration degree prediction apparatus 1 according to the present example embodiment may be implemented by a buried pipe deterioration degree prediction system 7. The buried pipe deterioration degree prediction system 7 includes a buried pipe deterioration degree prediction apparatus 1b, a burial environment classification map creation apparatus 2, a correspondence table creation apparatus 3, a buried pipe data reception device 4, and a storage device 5. The buried pipe deterioration degree prediction apparatus 1b, the burial environment classification map creation apparatus 2, the correspondence table creation apparatus 3, the buried pipe data reception device 4, and the storage device 5 are communicably connected to each other through a communication network 6 such as the Internet or an intranet. The hardware configuration of each of the buried pipe deterioration degree prediction apparatus 1b, the burial environment classification map creation apparatus 2, the correspondence table creation apparatus 3, and the buried pipe data reception device 4 is the same as the hardware configuration illustrated in FIG. 1. The storage device 5 includes, for example, a hard disk or a storage medium drive 17.

The correspondence table creation apparatus 3 has the functions of the correspondence table creator 90 (see FIG. 2). The correspondence creation table apparatus 3 creates a correspondence table 46. The buried pipe data reception device 4 has the functions of the buried pipe data receiver 99. The buried pipe data reception device 4 receives buried pipe data 50 from a client. The storage device 5 has the functions of the storage 20.

The burial environment classification map creation apparatus 2 has the functions of the map creator 100 (see FIG. 2). The burial environment classification map creation apparatus 2 is configured or programmed to include a first map creator 101 and a second map creator 102.

The buried pipe deterioration degree prediction apparatus 1b has the functions of the buried pipe deterioration degree predictor 130. Specifically, the buried pipe deterioration degree prediction apparatus 1b is configured or programmed to include a data preprocessor 131, a buried pipe deterioration degree calculator 132, a buried pipe deterioration degree prediction result creator 133, and a buried pipe deterioration degree prediction result output interface 134.

In the present example embodiment and the modification thereof, the number of the burial environment classifications is set to four burial environments A to D, but the number of the burial environment classifications is not limited to four.

The effects of the burial environment classification map creation apparatus 2, the buried pipe deterioration degree predicting device 1, the burial environment classification map creation method, the buried pipe deterioration degree predicting method, and the non-transitory computer-readable medium including a program according to the above example embodiments will be described.

The burial environment classification map creation apparatus 2 according to the present example embodiment is configured or programmed to include a first map creator 101 and a second map creator 102. The first map creator 101 creates, based on a pipeline map 51 which is a map of buried pipes and a generally available geological map 42, a general burial environment classification map 56a for a region corresponding to the pipeline map 51. The second map creator 102 includes a ground selector 103 and an optimized burial environment classification map creator 110. The ground selector 103 selects a portion of grounds from the general burial environment classification map 56a based on the water leakage accident data 53 which is a past record of water leakage accidents for each of the buried pipes. The optimized burial environment classification map creator 110 creates an optimized burial environment classification map (optimized burial environment classification map 58a) for the region corresponding to the pipeline map 51 by optimizing the burial environment classification of the portion of grounds by machine learning.

Therefore, it is possible to provide an optimized burial environment classification map (optimized burial environment classification map 58a) that enables more accurate prediction of the deterioration degree for each buried pipe.

In the burial environment classification map creation apparatus 2 of the present example embodiment, the second map creator 102 is configured or programmed to include an optimized burial environment classification map output interface (optimized integrated map output interface 118) that outputs an optimized burial environment classification map (optimized burial environment classification map 58a).

Therefore, it is possible to provide a burial environment classification map (optimized burial environment classification map 58a) to a client, which enables the client to plan a schedule for renewing buried pipes.

In the burial environment classification map creation apparatus 2 according to the present example embodiment, a portion of the grounds includes a first ground which is assigned a burial environment classification indicating a relatively high corrosivity in the general burial environment classification map 56a and is recorded with no water leakage accident in the water leakage accident data 53.

Therefore, it is possible to provide an optimized burial environment classification map (optimized burial environment classification map 58a) that enables more accurate prediction of the deterioration degree for each buried pipe.

In the burial environment classification map creation apparatus 2 according to the present example embodiment, a portion of the ground includes a second ground which is assigned a burial environment classification indicating a relatively low corrosivity in the general burial environment classification map 56a and is recorded with a water leakage accident in the water leakage accident data 53.

Therefore, it is possible to provide an optimized burial environment classification map (optimized burial environment classification map 58a) that enables more accurate prediction of the deterioration degree for each buried pipe.

The buried pipe deterioration degree prediction apparatus 1, 1b according to the present example embodiment is configured or programmed to include a buried pipe deterioration degree calculator 132. The buried pipe deterioration degree calculator 132 calculates a deterioration degree (for example, an estimated probability of water leakage accidents) for each of the buried pipes based on the burial environment of each of the buried pipes the optimized burial environment identified by classification map (optimized burial environment classification map 58a) optimized for a region corresponding to the pipeline map 51 which is a map of buried pipes, the first information (for example, the installation year of the buried pipe) relating to the burial period of each of the buried pipes, the second information (for example, the nominal diameter, the type of joint and the type of pipe wall thickness of each of the buried pipes) relating to the pipe wall thickness of each of the buried pipes, and the buried pipe deterioration degree prediction model (for example, the probability-of-water-leakage-accidents prediction model 28). The optimized burial environment classification map is created by optimizing a burial environment classification of a portion of grounds of the general burial environment classification map 56a for the region corresponding to the pipeline map 51 by machine learning. The general burial environment classification map 56a is created based on the pipeline map 51 and the generally available geological map 42. The portion of the ground is selected from the general burial environment classification map 56a based on the water leakage accident data 53 which is a past record of water leakage accidents for each of the buried pipes.

Therefore, it is possible to predict the deterioration degree for each of the buried pipes based on the optimized burial environment t classification map (optimized burial environment classification map 58a) optimized for the region corresponding to the pipeline map 51.

The buried pipe deterioration degree prediction apparatus 1, 1b according to the present example embodiment is configured or programmed to include a buried pipe deterioration degree prediction result output interface 134 that outputs a buried pipe deterioration degree prediction map 67 that is a map indicating a deterioration degree (for example, an estimated probability of water leakage accidents) for each of the buried pipes.

Therefore, it is possible to provide a burial environment classification map (optimized burial environment classification map 58a) to a client, which enables the client to plan a schedule for renewing buried pipes.

In the buried pipe deterioration degree prediction apparatus 1, 1b according to the present example embodiment, a portion of the grounds includes a first ground which is assigned a burial environment classification indicating a relatively high corrosivity in the general burial environment classification map 56a and is recorded with no water leakage accident in the water leakage accident data 53.

Therefore, it is possible to predict the deterioration degree for each buried pipe more accurately based on the optimized burial environment classification map (optimized burial environment classification map 58a) optimized for the region corresponding to the pipeline map 51.

In the buried pipe deterioration degree prediction apparatus 1, 1b according to the present example embodiment, a portion of the ground includes a second ground which is assigned a burial environment classification indicating a relatively low corrosivity in the general burial environment classification map 56a and is recorded with a water leakage accident in the water leakage accident data 53.

Therefore, it is possible to predict the deterioration degree for each buried pipe more accurately based on the optimized burial environment classification map (optimized burial environment classification map 58a) optimized for the region corresponding to the pipeline map 51.

In the buried pipe deterioration degree prediction apparatus 1, 1b according to the present example embodiment, the deterioration degree for each of the buried pipes refers to a probability (estimated probability of water leakage accidents) that a water leakage accident occurs in each buried pipe per unit time and unit distance.

Therefore, it is possible to predict the deterioration degree for each buried pipe more accurately based on the optimized burial environment classification map (optimized burial environment classification map 58a) optimized for the region corresponding to the pipeline map 51.

The burial environment classification map creation method according to the present example embodiment includes a step of creating, based on the pipeline map 51 which is a map of buried pipes and a generally available geological map 42, a general burial environment classification map 56a for a region corresponding to the pipeline map 51 (step S12), a step of selecting a portion of grounds from the general burial environment classification map 56a based on the water leakage accident data 53 which is a past record of water leakage accidents for each of the buried pipes, and a step of creating an optimized burial environment classification map (optimized burial environment classification map 58a) optimized for a region corresponding to the pipeline map 51 by optimizing the burial environment classification of the portion of grounds by machine learning (step S21).

Therefore, it is possible to provide an optimized burial environment classification map (optimized burial environment classification map 58a) that enables more accurate prediction of the deterioration degree for each buried pipe.

The burial environment classification map creation method according to the present example embodiment further includes a step of outputting the optimized burial environment classification map (optimized burial environment classification map 58a) (step S23).

Therefore, it is possible to provide a burial environment classification map (optimized burial environment classification map 58a) to a client, which enables the client to plan a renewal schedule for the buried pipe.

In the burial environment classification map creation method according to the present example embodiment, a portion of the grounds includes a first ground which is assigned a burial environment classification indicating a relatively high corrosivity in the general burial environment classification map 56a and is recorded with no water leakage accident in the water leakage accident data 53.

Therefore, it is possible to provide an optimized burial environment classification map (optimized burial environment classification map 58a) that enables more accurate prediction of the deterioration degree for each buried pipe.

In the burial environment classification map creation method according to the present example embodiment, a portion of the ground includes a second ground which is assigned a burial environment classification indicating a relatively low corrosivity in the general burial environment classification map 56a and is recorded with a water leakage accident in the water leakage accident data 53.

Therefore, it is possible to provide an optimized burial environment classification map (optimized burial environment classification map 58a) that enables more accurate prediction of the deterioration degree for each buried pipe.

The buried pipe deterioration degree prediction method according to the present example embodiment includes a step (step S70) of calculating a deterioration degree (for example, an estimated probability of water leakage accidents) for each of the buried pipes based on the burial environment of each of the buried pipes identified by the optimized burial environment classification map (optimized burial environment classification map 58a) optimized for a region corresponding to the pipeline map 51 which is a map of buried pipes, the first information (for example, the installation year of the buried pipe) relating to the burial period of each of the buried pipes, the second information (for example, the nominal diameter, the type of joint and the type of pipe wall thickness of each of the buried pipes) relating to the pipe wall thickness of each of the buried pipes, and the buried pipe deterioration degree prediction model (for example, the probability-of-water-leakage-accidents prediction model 28). The optimized burial environment classification map is created by optimizing a burial environment classification of a portion of grounds in the general burial environment classification map 56a machine learning. The general by burial environment classification map 56a is created based on the pipeline map 51 and the generally available geological map 42. The portion of the ground is selected from the general burial environment classification map 56a based on the water leakage accident data 53 which is a past record of water leakage accidents for each of the buried pipes.

Therefore, it is possible to predict the deterioration degree for each buried pipe more accurately based on the optimized burial environment classification map (optimized burial environment classification map 58a) optimized for the region corresponding to the pipeline map 51.

The buried pipe deterioration degree prediction method according to the present example embodiment further includes a step of outputting a buried pipe deterioration degree prediction map 67 which is a map indicating a deterioration degree (for example, an estimated probability of water leakage accidents) for each of the buried pipes (step S81).

Therefore, it is possible to provide a burial environment classification map (optimized burial environment classification map 58a) to a client, which enables the client to plan a schedule for renewing buried pipes.

In the buried pipe deterioration degree prediction method according to the present example embodiment, a portion of the grounds includes a first ground which is assigned a burial environment classification indicating a relatively high corrosivity in the general burial environment classification map 56a and is recorded with no water leakage accident in the water leakage accident data 53.

Therefore, it is possible to predict the deterioration degree for each buried pipe more accurately based on the optimized burial environment classification map (optimized burial environment classification map 58a) optimized for the region corresponding to the pipeline map 51.

In the buried pipe deterioration degree prediction method according to the present example embodiment, a portion of the ground includes a second ground which is assigned a burial environment classification indicating a relatively low corrosivity in the general burial environment classification map 56a and is recorded with a water leakage accident in the water leakage accident data 53.

Therefore, it is possible to predict the deterioration degree for each buried pipe more accurately based on the optimized burial environment classification map (optimized burial environment classification map 58a) optimized for the region corresponding to the pipeline map 51.

In the buried pipe deterioration degree prediction method according to the present example embodiment, the deterioration degree for each of the buried pipes refers to a probability (estimated probability of water leakage accidents) that a water leakage accident occurs in each buried pipe per unit time and unit distance.

Therefore, it is possible to predict the deterioration degree for each buried pipe more accurately based on the optimized burial environment classification map (optimized burial environment classification map 58a) optimized for the region corresponding to the pipeline map 51.

The program (burial environment classification map creation program 31) according to the present example embodiment causes the processor 12 to execute each step of the burial environment classification map creation method according to the present example embodiment.

Therefore, it is possible to provide an optimized burial environment classification map (optimized burial environment classification map 58a) that enables more accurate prediction of the deterioration degree for each buried pipe.

The program (for example, the buried pipe deterioration degree prediction program 32) according to the present example embodiment causes the processor 12 to execute each step of the buried pipe deterioration degree prediction method according to the present example embodiment.

Therefore, it is possible to predict the deterioration degree for a buried pipe more accurately based on the burial environment classification map (optimized burial environment classification map 58a) optimized for the region corresponding to the pipeline map 51.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A burial environment classification map creation apparatus comprising:
at least one of a processor or an integrated circuit configured or programmed to include:
a first map creator configured or programmed to create, based on a pipeline map which is a map of buried pipes and a generally available geological map, a general burial environment classification map for a region corresponding to the pipeline map; and
a second map creator configured or programmed to include a ground selector and an optimized burial environment classification map creator; wherein
the ground selector is configured or programmed to select a portion of grounds from the general burial environment classification map based on leakage accident data which is a past record of water leakage accidents for each of the buried pipes; and
the optimized burial environment classification map creator is configured or programmed to create an optimized burial environment classification map for the region by optimizing a burial environment classification of the portion of grounds by machine learning.

2. The burial environment classification map creation apparatus according to claim 1, wherein the second map creator is configured or programmed to include an optimized burial environment classification map output interface to output the optimized burial environment classification map.

3. The burial environment classification map creation apparatus according to claim 1, wherein the portion of grounds includes a first ground which is assigned a burial environment classification indicating a relatively high corrosivity in the general burial environment classification map and is recorded with no water leakage accident in the water leakage accident data.

4. The burial environment classification map creation apparatus according to claim 1, wherein the portion of grounds includes a second ground which is assigned a burial environment classification indicating a relatively low corrosivity in the general burial environment classification map and is recorded with a water leakage accident in the water leakage accident data.

5. A buried pipe deterioration degree prediction apparatus comprising:
at least one of a processor or an integrated circuit configured or programmed to include:
a buried pipe deterioration degree calculator configured or programmed to calculate a deterioration degree for each of buried pipes based on a burial environment of each of the buried pipes identified by an optimized burial environment classification map optimized for a region corresponding to a pipeline map which is a map of the buried pipes, first information related to a burial period of each of the buried pipes, second information related to a pipe wall thickness of each of the buried pipes, and a buried pipe deterioration degree prediction model; wherein
the optimized burial environment classification map is created by optimizing a burial environment classification of a portion of grounds in a general burial environment classification map for the region by machine learning;
the general burial environment classification map is created based on the pipeline map and a generally available geological map; and
the portion of grounds is selected from the general burial environment classification map based on water leakage accident data which is a past record of water leakage accidents for each of the buried pipes.

6. The buried pipe deterioration degree prediction apparatus according to claim 5, further comprising:
a buried pipe deterioration degree prediction result output interface configured or programmed to output a buried pipe deterioration degree prediction map which is a map indicating a deterioration degree for each of the buried pipes.

7. The buried pipe deterioration degree prediction apparatus according to claim 5, wherein the portion of grounds includes a first ground which is assigned a burial environment classification indicating a relatively high corrosivity in the general burial environment classification map and is recorded with no water leakage accident in the water leakage accident data.

8. The buried pipe deterioration degree prediction apparatus according to claim 5, wherein the portion of grounds includes a second ground which is assigned a burial environment classification indicating a relatively low corrosivity in the general burial environment classification map and is recorded with a water leakage accident in the water leakage accident data.

9. The buried pipe deterioration degree prediction apparatus according to claim 5, wherein the deterioration degree for each of the buried pipes represents a probability that a water leakage accident occurs in each of the buried pipes per unit time and per unit distance.

10. A burial environment classification map creation method comprising:
a step of creating, based on a pipeline map which is a map of buried pipes and a generally available geological map, a general burial environment classification map for a region corresponding to the pipeline map;
a step of selecting a portion of grounds from the general burial environment classification map based on water leakage accident data which is a past record of water leakage accidents for each of the buried pipes; and
a step of creating an optimized burial environment classification map for the region by optimizing a burial environment classification of the portion of grounds by machine learning.

11. The burial environment classification map creation method according to claim 10, further comprising:
a step of outputting the optimized burial environment classification map.

12. The burial environment classification map creation method according to claim 10, wherein the portion of grounds includes a first ground which is assigned a burial environment classification indicating a relatively high corrosivity in the general burial environment classification map and is recorded with no water leakage accident in the water leakage accident data.

13. The burial environment classification map creation method according to claim 10, wherein the portion of grounds includes a second ground which is assigned a burial environment classification indicating a relatively low corrosivity in the general burial environment classification map and is recorded with a water leakage accident in the water leakage accident data.

14. A buried pipe deterioration degree prediction method comprising:
a step of calculating a deterioration degree for each of buried pipes based on a burial environment of each of the buried pipes identified by an optimized burial environment classification map optimized for a region corresponding to a pipeline map which is a map of the buried pipes, first information related to a burial period of each of the buried pipes, second information related to a pipe wall thickness of each of the buried pipes, and a buried pipe deterioration degree prediction model; wherein
the optimized burial environment classification map is created by optimizing a burial environment classification of a portion of grounds in a general burial environment classification map for the region by machine learning;
the general burial environment classification map is created based on the pipeline map and a generally available geological map; and
the portion of grounds is selected from the general burial environment classification map based on water leakage accident data which is a past record of water leakage accidents for each of the buried pipes.

15. The buried pipe deterioration degree prediction method according to claim 14, further comprising:
a step of outputting a buried pipe deterioration degree prediction map which is a map indicating the deterioration degree for each of the buried pipes.

16. The buried pipe deterioration degree prediction method according to claim 14, wherein the portion of grounds includes a first ground which is assigned a burial environment classification indicating a relatively high corrosivity in the general burial environment classification map and is recorded with no water leakage accident in the water leakage accident data.

17. The buried pipe deterioration degree prediction method according to claim 14, wherein the portion of grounds includes a second ground which is assigned a burial environment classification indicating a relatively low corrosivity in the general burial environment classification map and is recorded with a water leakage accident in the water leakage accident data.

18. The buried pipe deterioration degree prediction method according to claim 14, wherein the deterioration degree for each of the buried pipes represents a probability that a water leakage accident occurs in each of the buried pipes per unit time and per unit distance.

19. A non-transitory computer-readable recording medium having instructions recorded thereon, that when executed on a processor, perform each step of the burial environment classification map creation method according to claim 10.

20. A non-transitory computer-readable recording medium having instructions recorded thereon, that when executed on a processor, perform each step of the buried pipe deterioration degree prediction method according to claim 14.
